(19) United States
(12) Patent Application Publication
(10) Pub. No.: US 2005/0158489 A1
(43) Pub. Date: Jul. 21, 2005

(54) Ink-jet recording medium and process for producing the same

(75) Inventors: Kozo Nagata, Shizuoka-ken (JP); Tetsunori Matsushita, Shizuoka-ken (JP); Tadashi Inaba, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 11/014,186

(22) Filed: Dec. 17, 2004

(30) Foreign Application Priority Data
Dec. 17, 2003 (JP) 2003-419239

(51) Int. Cl. B41M 5/00

(52) U.S. Cl. 428/32.38

(57) ABSTRACT

An ink-jet recording medium including a substrate and an ink-receiving layer disposed on the substrate. The ink-receiving layer includes a water-soluble resin, a first cationic organic polymer having an inorganicity/organicity (I/O) ratio of less than 2.8 and a second cationic organic polymer having an inorganicity/organicity (I/O) ratio of 2.8 or more.

### CROSS-REFERENCE TO RELATED APPLICATION

This application claims priority under 35USC 119 from Japanese Patent Application No. 2003-419239, the disclosure of which is incorporated by reference herein.

### BACKGROUND OF THE INVENTION

1. Field of the Invention

The present invention relates to a recording medium subjected to ink-jet recording using a liquid ink such as a water-based ink (using dyes or pigments as colorants) or an oil-based ink, or a solid ink that is a solid at room temperature while used for printing by melting and liquefying. Particularly, the invention relates to an ink-jet recording medium excellent in ozone resistance and a process for manufacturing the same.

2. Description of the Related Art

With the rapid development of the information technology (IT) industry, various information processing systems, as well as recording method and recording apparatus suitable for the information processing systems, have been developed and practically used. Among these recording methods, an ink-jet recording method has been widely used in offices as well as in homes due to advantages such as recordability on various recording materials, cheap and compact design of hardware therefor, and quietness during operation. So-called photograph-like high-image quality printed matter has come to be obtainable as a result of the development of high resolution ink-jet printers in recent years, and various recording sheets have also been developed along with the progress of the hardware.

Generally, characteristics required for an ink-jet recording sheet include (1) rapid drying (high absorption speed of ink), (2) appropriate and uniform diameter of ink dots (no blurring), (3) good granularity, (4) high circularity of dots, (5) high color density, (6) high color saturation (no dullness), (7) good water resistance, light fastness and ozone resistance of printed portions, (8) high whiteness of the recording sheet, (9) good storability of the recording sheet (no occurrence of yellowing or blurring of the image even upon long term storage (prevention of time-dependent blurring)), (10) hardly deformable and good dimensional stability (sufficiently small curling), and (11) good running properties with respect to hardware. Glossiness, surface smoothness and a photographic paper-like feeling resembling that of a silver salt photograph are also required in addition to the above-mentioned characteristics in applications as photographic glossy paper used for obtaining so-called photograph-like, high-image quality printed matter.

For improving the above-described characteristics, ink-jet recording media having an ink-receiving layer with a porous structure have been developed and used in recent years. Such an ink-jet recording medium has excellent ink receptivity (rapid drying property) and high glossiness due to provision of the porous structure.

For example, an ink-jet recording medium comprising an ink-receiving layer containing fine inorganic pigment particles and a water-soluble resin and having a high void ratio, provided on a substrate, has been proposed in recent years (for example, see Japanese Patent Application Laid-Open (JP-A) Nos. 10-119423 and 10-217601). Such a recording sheet, particularly an ink-jet recording medium having a porous structure using silica as the inorganic pigment fine articles, is excellent in ink absorption property, and has high ink receiving performance capable of forming high resolution images, and exhibits high glossiness, due to its construction. Consequently, the recording medium is practically able to exhibit an image comparable to the image obtained by silver salt photography.

However, image storability of the ink-jet recording medium is insufficient as compared with a silver salt photograph, and significant improvement is desired. While light fastness in relation to deterioration of the image by light has conventionally been emphasized with respect to image storability, minute amounts of gases in air, particularly ozone, cause color fading of the recorded image over time. Since the recording material comprising the ink-receiving layer having the porous structure contains many voids, the recorded image tends to be readily faded by the ozone gas in air. Therefore, it is a very important issue for the recording material having such a porous ink-receiving layer as described above to improve resistance against ozone in the air (ozone resistance).

JP-A No. 2001-260519 has proposed an ink-jet recording material containing sulfinic acid compounds, thiosulfonic acid compounds, thiosulfinic acid compounds or thiourea compounds for preventing color fading due to ozone. EP 1138509 has proposed an ink-jet recording material containing thioether compounds having hydrophilic groups. Other methods proposed include methods for allowing the ink layer to contain urea derivatives, semicarbazide derivatives, carbohydrazide derivatives or hydrazine derivatives (for example, see JP-A No. 07-314881 and EP 1219459). However, although these methods are effective for ozone resistance, there is a problem in that the effect of adding these compounds does not last long and cannot endow the ink-jet recording material with sufficient ozone resistance for a long period of time.

JP-A No. 07-314882 has disclosed a recording sheet having a porous ink-receiving layer comprising at least one compound selected from the group consisting of dithiocarbamates, thiuram salts, thiocyanate esters, thiocyanates and hindered amine compounds. Examples of the hindered amine compounds are compounds having a structure in which all hydrogen atoms on the 2-position and 6-position carbon atoms in the piperidine ring are substituted with methyl groups. While this recording sheet has a color-fading preventive effect for about 30 days in an indoor environment due to containing the compounds, it remains as a problem that the recording sheet cannot be endowed with long term ozone resistance.

Other examples of recording sheets for improving ozone resistance include ink-jet recording media containing cationic polymers such as (1) an ink-jet recording material having an ink absorbing layer obtained by mixing two kinds of polymers comprising, as a structural unit, a monomer having a quaternary ammonium salt group, followed by three-dimensional crosslinking using a curing agent (for example, see JP-A No. 08-142496),
(2) a recording medium containing polyallyamine and a cationic substance having a molecular weight of not higher than 1000 (for example, see JP-A No. 07-266689), (3) a recording medium comprising a water-soluble magnesium salt, an N-vinyl acrylamidine copolymer and polyamine resin in a specific ratio (for example, see JP-A No. 2000-343813), (4) a recording sheet containing a cationic polymer compound such as a methacrylic acid quaternary ammonium salt derivative and a cationic polymer compound such as an alkylamine-epichlorohydrin polymer at a specified cation density (for example, see JP-A No. 2000-272234), (5) a recording sheet for a water-based ink comprising a copolymer of a (meth)acrylate monomer containing a quaternary ammonium salt and N-vinylpyrrolidone and polyamidine (for example, see JP-A No. 2001-171230), (6) an ink-jet recording sheet having an ink-absorbing layer containing at least two kinds of cationic polymers (for example, see JP-A No. 2001-039026), and (7) an ink-jet recording material comprising a surface layer containing a diallylammonium salt at the outermost layer and a cationic polymer on a substrate (for example, see JP-A No. 2001-315428).

However, the current situation is that the stability of dispersion solutions of fine particles such as silica fine particles is limited, and that highly hydrophilic cationic polymers effective for enhancing ozone resistance have not been sufficiently utilized. In addition to having ozone resistance, the ink-jet recording medium has been also required to be able to form high density images with excellent glossiness in recent years in order to form photograph-like high quality images. However, dyes contained in the ink may reduce image density by causing excessive coagulation depending on the kind of mordants combined with the dye. Accordingly, development of an inkjet recording medium having high fastness to ozone, providing high image density, and exhibiting excellent glossiness is desired.

### SUMMARY OF THE INVENTION

The present invention has been made in view of the above-mentioned circumstances, and provides an ink-jet recording medium and a manufacturing method thereof, wherein ozone resistance of the image formed is excellent for a long period of time and the image can be obtained with high glossiness and high density, while productivity is excellent due to low viscosity and stability of coating liquids.

A first aspect of the invention is to provide an ink-jet recording medium comprising a substrate and an ink-receiving layer disposed on the substrate. The ink-receiving layer comprises a water-soluble resin, a first cationic organic polymer having an inorganicity/organicity (I/O) ratio of less than 2.8 and a second cationic organic polymer having an inorganicity/organicity (I/O) ratio of 2.8 or more.

A second aspect of the invention is to provide a method for producing the ink-jet recording medium recited in the first aspect of the invention. The method comprises: coating, on a substrate, a coating liquid comprising a water-soluble resin, a first cationic organic polymer having an I/O ratio of less than 2.8 and a second cationic organic polymer having an I/O ratio of 2.8 or more so as to form a coating layer; and applying a basic solution having a pH of 7.1 or more onto the coating layer either (1) simultaneously with formation of the coating layer by application of the coating liquid or (2) during drying of the coating layer formed by application of the coating liquid and before the coating layer exhibits a decreasing rate of drying so as to cure the coating layer. Here, a crosslinking agent has been added to at least one of the coating liquid and the basic solution.

According to the invention, the ink-jet recording medium with images having good long term ozone resistance and printed images excellent in glossiness and density, and the producing method thereof can be provided.

### DETAILED DESCRIPTION OF THE INVENTION

The inkjet recording medium of the present invention comprises a substrate and an ink-receiving layer disposed on the substrate. The ink-receiving layer comprises a water-soluble resin, at least a cationic organic polymer having an inorganicity/organicity ratio (I/O ratio) of less than 2.8 (hereinafter, sometimes referred to as “first cationic organic polymer”) and at least a cationic organic polymer having an inorganicity/organicity ratio (I/O ratio) of 2.8 or more (hereinafter, sometimes referred to as “second cationic organic polymer”). Hereinafter, both the first and second cationic organic polymers may be referred to as “cationic organic polymers of the invention”. The ink-receiving layer of the invention may further contain fine particles, chelating agents, sulfur-containing compounds, or the like.

The ink-jet recording medium of the invention, the ink-receiving layer of which contains the water-soluble resin and the above-mentioned cationic organic polymers, is able to provide printed images that maintain ozone resistance for a long period of time while the provided images exhibit high color density and excellent glossiness. The ink-jet recording medium of the invention is also able to be excellent in water resistance and ink absorbing property so as to suppress time-dependent blurring and to prevent defects such as cracks.

Constituting elements of the ink-jet recording medium of the present invention will be described in detail hereinafter. It should be noted that these descriptions and exemplified compounds do not limit the scope of the invention.

(Cationic Organic Polymers of the Invention)

The cationic organic polymers of the invention may preferably have at least one of primary, secondary, tertiary or quaternary amino groups. The cationic organic polymer preferably has a weight average molecular weight of 500 to 100,000, and more preferably 800 to 80,000, in view of ink absorbing property of the ink-receiving layer.

Specific examples of the cationic organic polymers of the invention include polymers and copolymers of trimethyl-p-vinylbenzyl ammonium chloride, trimethyl-m-vinylbenzyl ammonium chloride, triethyl-p-vinylbenzyl ammonium chloride, triethyl-m-vinylbenzyl ammonium chloride, N,N-dimethyl-N-ethyl-p-vinylbenzyl ammonium chloride, N,N-diethyl-N-methyl-p-vinylbenzyl ammonium chloride, N,N-dimethyl-N-propyl-p-vinylbenzyl ammonium chloride, N,N-dimethyl-N-octyl-p-vinylbenzyl ammonium chloride, N,N-dimethyl-N-benzyl-p-vinylbenzyl ammonium chloride, N,N-diethyl-N-benzyl-p-vinylbenzyl ammonium chloride, N,N-dimethyl-N-(4-methyl)-p-vinylbenzyl ammonium chloride, N,N-dimethyl-N-phenyl-p-vinylbenzyl ammonium chloride; trimethyl-p-vinylbenzyl ammonium bromide, trimethyl-m-vinylbenzyl ammonium bromide, trimethyl-p-vinylbenzyl ammonium sulfonate, trimethyl-m-vinylbenzyl ammonium sulfonate, trimethyl-p-vinylbenzyl ammonium acetate, trimethyl-m-vinylbenzyl ammonium acetate, N,N,N-triethyl-N-2-(4-vinylphenyl)ethyl ammonium chloride, N,N,N-triethyl-N-2-(3-vinylphenyl)ethyl ammonium chloride, N.N-diethyl-N-methyl-N-2-(4-vinylphenyl)ethyl ammonium chloride, N.N-diethyl-N-methyl-N-2-(4-vinylphenyl)ethyl ammonium acetate; N,N-dimethylaminoethyl(meth)acrylate, N,N-diethylaminoethyl (meth)acrylate, N,N-dimethylaminopropyl(meth)acrylate, N,N-diethylaminopropyl (meth)acrylate, N,N-dimethylaminoethyl (meth)acrylamide, N,N-diethylaminoethyl(meth)acrylamide, N,N-dimethylaminopropyl (meth)acrylamide, and N,N-diethylaminopropyl (meth)acrylamide; polymers and copolymers of quaternary compounds thereof with methyl chloride, ethyl chloride, methyl bromide, ethyl bromide, methyl iodide or ethyl iodide; and polymers and copolymers of sulfonates, alkylsulfonates, acetates, alkylcarboxylates or the like prepared by substituting the anion of the above-mentioned compounds.

Further specific examples include polymers and copolymers of trimethyl-2-(methacryloyloxy)ethyl ammonium chloride, triethyl-2-(methacryloyloxy)ethyl ammonium chloride, trimethyl-2-(acryloyloxy)ethyl ammonium chloride, triethyl-2-(acryloyloxy)ethyl ammonium chloride, trimethyl-2-(methacryloyloxy)propyl ammonium chloride, triethyl-2-(methacryloyloxy)propyl ammonium chloride, trimethyl-2-(methacryloylamino)ethyl ammonium chloride, triethyl-2-(methacryloylamino)ethyl ammonium chloride, trimethyl-2-(acryloylamino)ethyl ammonium chloride, triethyl-2-(acryloylamino)ethyl ammonium chloride, trimethyl-3-(methacryloylamino)propyl ammonium chloride, triethyl-3-(methacryloylamino)propyl ammonium chloride, trimethyl-3-(acryloylamino)propyl ammonium chloride, triethyl-3-(acryloylamino)propyl ammonium chloride; N,N-dimethyl-N-ethyl-2-(methacryloyloxy)ethyl ammonium chloride, N,N-diethyl-N-methyl-2-(methacryloyloxy)ethyl ammonium chloride, N,N-dimethyl-N-ethyl-2-(acryloylamino)propyl ammonium chloride, trimethyl-2-(methacryloyloxy)ethyl ammonium bromide, trimethyl-3-(acryloylamino)propyl ammonium bromide, trimethyl-2-(methacryloyloxy)ethyl ammonium sulfonate, trimethyl-3-(acryloylamino)propyl ammonium acetate, and the like.

Polymers and copolymers of N-vinyl imidazole and N-vinyl-2-methyl imidazole may also be used.

Furthermore, polymers and copolymers of allylamine, diallylamine, derivatives thereof and salts thereof may also be used. Examples of these compounds include polymers and copolymers of allylamine, allylamine hydrochloride, allylamine acetate, allylamine sulfate, diallylamine, diallylamine hydrochloride, diallylamine acetate, diallylamine sulfate, diallymethylamine and salts thereof (for example hydrochloride, acetate and sulfate), diallyethylamine and salts thereof (for example hydrochloride, acetate and sulfate), and diallyldimethyl ammonium salts (with counter-ions such as hydrochloride, acetate and sulfate). It may be noted that, since allylamine and diallylamine derivatives in the form of amines are inferior in polymerizing ability, these are generally polymerized in the form of salts thereof and desalted later, if necessary.

Structural units such as N-vinyl acetamide and N-vinyl formamide may be polymerized, and after polymerization, the polymer may be converted into vinylamine units by hydrolysis, and the salts thereof may also be used.

The ink-receiving layer comprises at least one cationic organic polymer having an inorganicity/organicity ratio (I/O ratio) of less than 2.8 (first cationic organic polymer) and at least one cationic organic polymer having an inorganicity/organicity ratio (I/O ratio) of 2.8 or more (second cationic organic polymer). Known compounds may be used as the compounds for forming such cationic organic polymer.

The inorganicity/organicity ratio (I/O ratio) is a parameter representing a scale of hydrophilicity/hydrophobicity ratio as described in detail in “Organic Conception Diagram” (Yoshio Koda, Sankyo Shuppan (1984)), the disclosure of which is hereby incorporated by reference. Furthermore, the inorganicity/organicity ratio (I/O ratio) is referred to in U.S. Patent Application Publication No. 2002/0064633 (disclosure of which is hereby incorporated by reference), and the calculation of I/O value is explained therein. “I” represents inorganicity, and “O” represents organicity. The larger I/O ratio means larger inorganicity (or higher polarity and higher hydrophilicity). An I/O ratio is used as a method for representing the contribution of functional groups by assigning a parameter for each functional group, and the value of inorganicity and organicity can be determined for each functional group. Functional groups which constitute the cationic organic polymers of the invention should be selected according to this parameter.

A concrete example of calculating an I/O ratio will be described below. For example, I-value for —NHCO— group is 200, I-value for —NHSO₃— group is 240, and I-value for —COO— group is 60. For example, an I/O ratio of —NHCOC₅H₁₁ group is approximately 1.67 (=I/O) since the number of the carbon atoms is 6, O-value is 20×6=120 and I=200.

When the ink-receiving layer of the invention contains at least one cationic organic polymer having the inorganicity/organicity (I/O) ratio of 2.8 or more, the ink-receiving layer exhibits an effect for improving ozone resistance, water resistance and moisture resistance.

However, if an I/O ratio is too high, absorbing property to fine particles deteriorates, and dispersion stability of the fine particles tends to be reduced. Further, blurring of images is likely to occur when images are stored under a high humidity environment. Accordingly, the I/O ratio is preferably in a range of 2.8 to 10 when it is high, and more preferably in a range of 2.8 to 6.0.

When the ink-receiving layer of the invention contains at least one cationic organic polymer having the inorganicity/organicity (I/O) ratio of less than 2.8, the ink-receiving layer exhibits an effect for improving dispersion stability of fine particles and viscosity stability of the coating liquid.

However, if an I/O ratio is too low, solubility in water is reduced and dispersion stability of the fine particles tends to decrease. Accordingly, the I/O ratio is preferably in a range of 1 or more and less than 2.8 when it is low, and more preferably in a range of 1.8 or more and less than 2.8.

Any combinations of the cationic organic polymers may be used in the invention insofar as the polymers satisfy the above-described I/O ratio.

Examples of the second cationic organic polymer having an inorganicity/organicity (I/O) ratio of 2.8 or more include polyallylamine, polyethyleneimine, polyvinylamine, polyamidine, a dimethylamine-epichlorohydrin polycondensation product and a dicyan-diamide polycondensation product. Among them, a dimethylamine-epichlorohydrin polycondensation product and a dicyan-diamide polycondensation product are more preferable. Further, a dimethylamine-epichlorohydrin-polyalkylene polyamine polycondensation product and a dicyandiamide-polyalkylene polyamine polycondensation product are particularly preferable.

Examples of the first cationic organic polymer having an inorganicity/organicity (I/O) ratio of less than 2.8 include dimethyldiallyl ammonium chloride, (meth)acrylate of a trialkylammonium salt, and a copolymer of (meth)acrylate of a trialkylammonium salt and styrene. Among them, dimethyldiallyl ammonium chloride, and a copolymer of trimethylammonium ethyl methacrylate and styrene are particularly preferable.

A mass content ratio (a:b) of (a) a first cationic organic polymer having an inorganicity/organicity (I/O) ratio of less than 2.8 and (b) a second cationic organic polymer having an inorganicity/organicity (I/O) ratio of 2.8 or more is preferably in a range of 1:5 to 40:1, more preferably in a range of 1:2 to 10:1, and still more preferably in a range of 1:1 to 5:1 in view of compatibility between improved ozone resistance and production suitability. Stability of the coating liquid decreases to impair production suitability when the content of the second cationic polymer of (b) increases with the mass content ratio of out of the ratio of 1:5, while improvement of ozone resistance becomes insufficient when the content of the first cationic polymer of (a) increases with the mass content ratio of out of the ratio of 40:1. Therefore, it is not preferable if the contents of cationic polymers (a) and (b) are out of the above-mentioned ranges.

The total amount of the cationic polymers to be used is preferably 0.1 to 5 g/m², more preferably 0.25 to 3.5 g/m², and still more preferably 0.5 to 2 g/m². Improvement of ozone resistance may be insufficient when the total amount to be used is less than 0.1 g/m², while stability of the coating liquid decreases to impair production suitability when the total amount to be used exceeds 5 g/m². Therefore, the total amount of the cationic polymers should be preferably within the above-mentioned ranges.

The methods for using the cationic polymers having the two kinds of the I/O ratios at the same time are not particularly limited, and may be variously selected depending on objects and requirements. However, the cationic polymers and the fine particles such as silica fine particles to be described below are preferably added in the same coating liquid in view of improvement of ozone resistance and stability of the dispersion solution.

(Chelating Agent)

The ink-receiving layer of the ink-jet recording medium of the invention preferably comprises at least one chelating agent for improving ozone resistance and stability of the fine particle dispersion solution.

The chelating agent works not only for improving ozone resistance. The present inventors have found that the chelating agent is further able to form a stable coating solution having a low viscosity by using it in combination with inorganic particles having a primary diameter of 50 nm or less, polyvinyl alcohol having a degree of polymerization of 1000 or more and boric acid.

The chelating agent is preferably represented by the following formula (I) or (II):

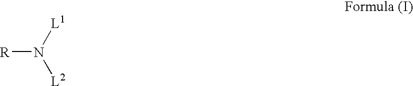

In formula (I), L¹ and L² each independently represent: 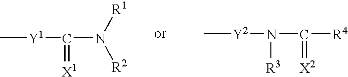
wherein X¹ and X¹² each independently represent an oxygen atom or a sulfur atom; R, R¹, R² and R³ each independently represent a hydrogen atom, an alkyl group or an aryl group; R⁴ represents a substituted or unsubstituted alkyl group, aryl group, —N(R⁵)R⁶ or —OR⁷; and R⁵ and R⁶ each independently have the same meaning as R¹. R⁷ represents an alkyl group or aryl group; and Y¹ and Y² each independently represent an alkylene group or arylene group. R, L¹ and L² may be bonded to each other to form a ring, and R¹ and R² may also be bonded to each other to form a ring.

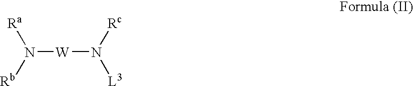

In formula (II), L³ represents: 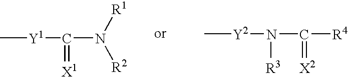
wherein X¹ and X², Y¹ and Y², and R¹ to R⁴ have the same meaning as X¹ and X², Y¹ and Y², and R¹ to R⁴ of formula (I), respectively. R^{a} to R^{c} each independently represent a hydrogen atom, an alkyl group or an aryl group, and R^{a} to R^{c} and L³ may be bonded to each other to form a ring. W represents a divalent linking group.

Specific examples of the compound represented by formulae (I) and (II) include ethylenediamine tetraacetic acid and salts thereof, compounds B-1 to B-79 described in JP-A No. 4-73647, compounds 1 to 53 described in JP-A No. 6-11805, and salts thereof.

The amount of the chelating agent to be used is preferably 0.01 to 5 g/m², more preferably 0.05 to 3 g/m², and particularly preferably 0.1 to 1 g/m². The ozone resistance improving effect may be insufficient when the amount to be used is less than 0.01 g/m², while stability of the coating solution may be reduced to impair production suitability when the amount to be used exceeds 5 g/m². Therefor, it is not preferable if the amount to be used is out of the above-mentioned preferable ranges.

(Sulfur-Containing Compound)

The ink-jet recording medium of the invention preferably contains at least one sulfur-containing compound for further improving ozone resistance.

The sulfur-containing compound used in the invention is preferably at least one selected from the compounds represented by the following formulae (1) to (5):
R¹—S—R² Formula (1)
R⁴—S—S—R⁵ Formula (2)
R³—SH Formula (3)
R⁶—S(═O)—R⁷ Formula (4)
X—(Y¹—S)ₘ—(Y²—S)ₙ—Y³—X Formula (5)

In formulae (1) to (4), R¹, R², R³, R⁴, R⁵. R⁶ and R⁷ each independently represent a substituted or unsubstituted alkyl group, a substituted or unsubstituted aryl group, or a substituted or unsubstituted heterocyclic ring. R¹ and R², R³ and R⁴, and R⁶ and R⁷ may be bonded to each other to form a ring.

In formula (5), X represents a hydroxyl group, a carboxyl group, a carboxylate, an amino group, or a group having at least one of these groups. Y¹, Y² and Y³ each independently represent an alkylene group. n represents an integer of 1 to 6, and m represents 0 or 1.

The alkyl groups represented by R¹ to R⁷ in formulae (1) to (4) may be linear or branched alkyl groups, and preferably have 1 to 20 carbon atoms, and more preferably 1 to 12 carbon atoms. Examples of such alkyl groups include methyl, ethyl, n-propyl, i-propyl, n-butyl, i-butyl, sec-butyl, n-pentyl, n-hexyl and 2-ethylhexyl groups. Among them, methyl, ethyl, n-propyl and i-propyl groups are particularly preferable. When the alkyl groups represented by R¹ to R⁷ have a substituent, the substituent is preferably a hydroxyl group, a carboxyl group, a sulfonic acid group or an amino group. Among them, a hydroxyl group and a carboxyl group are particularly preferable.

The aryl group represented by R¹ to R⁷ preferably has 6 to 20 carbon atoms, and more preferably 6 to 12 carbon atoms. Examples of such an aryl group include phenyl, naphthyl and anthranyl groups, and a phenyl group is preferable among them. When the aryl groups represented by R¹ to R⁷ have a substituent, the substituent may preferably a hydroxyl group, a thiol group, a methyl group or a t-butyl group, and a methyl group and a thiol group are particularly preferable among them.

Examples of the heterocyclic groups represented by R¹ to R⁷ include heterocyclic groups containing a nitrogen, oxygen or sulfur atom. The total number of the atoms of carbon, nitrogen, sulfur and oxygen is preferably 1 to 20, and more preferably 1 to 12. Preferable examples of such heterocyclic rings include furyl, thienyl, pyridyl, pyrazolyl, isooxazolyl, imidazolyl, oxazolyl, thiazolyl, pyridazoyl, pyrimidiyl, pyrazolyl triazolyl, tetrazolyl, quinolyl, benzothiazolyl, benzoxazolyl, benzimidazolyl, isoquinolyl, thiadiazolyl, morpholino, piperidino, piperazino, indolyl and isoindolyl groups. These heterocyclic groups may have a substituent, and examples of such a substituent are the same as the substituents in the above-described substituted alkyl groups. Among the above-described preferable heterocyclic groups, furyl, thienyl, pyridyl, morpholino and piperidino groups are more preferable.

The compounds represented by formulae (1) to (4) are preferably water-soluble, since such water-soluble compounds permit the effects for improving ozone resistance and light fastness to be readily exhibited. At least one of R¹ and R², at least one of R⁴ and R⁵, and at least one of R⁶ and R⁷ preferably have a substitutent. Such a substituent is preferably one selected from the group consisting of a hydroxyl group, a carboxyl group, a carboxylate, an amino group, a sulfonic group and a sulfonate. Among them, a hydroxyl group, a carboxyl group and a carboxylate are more preferable.

Preferable examples of the compounds represented by formulae (1) to (4) used for the ink-jet recording medium of the invention are listed below. However, these examples should not be construed to limit the scope of the present invention.

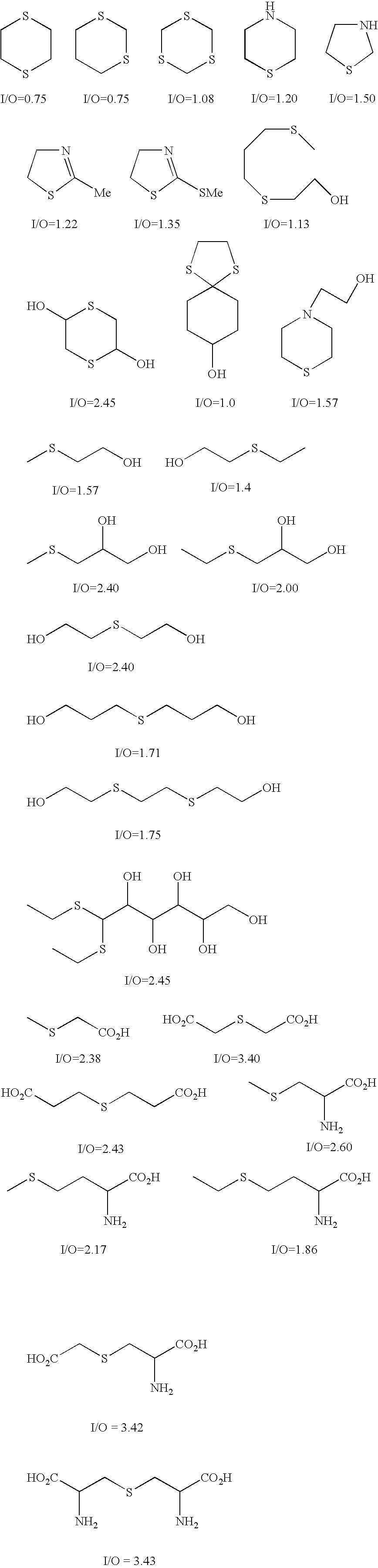

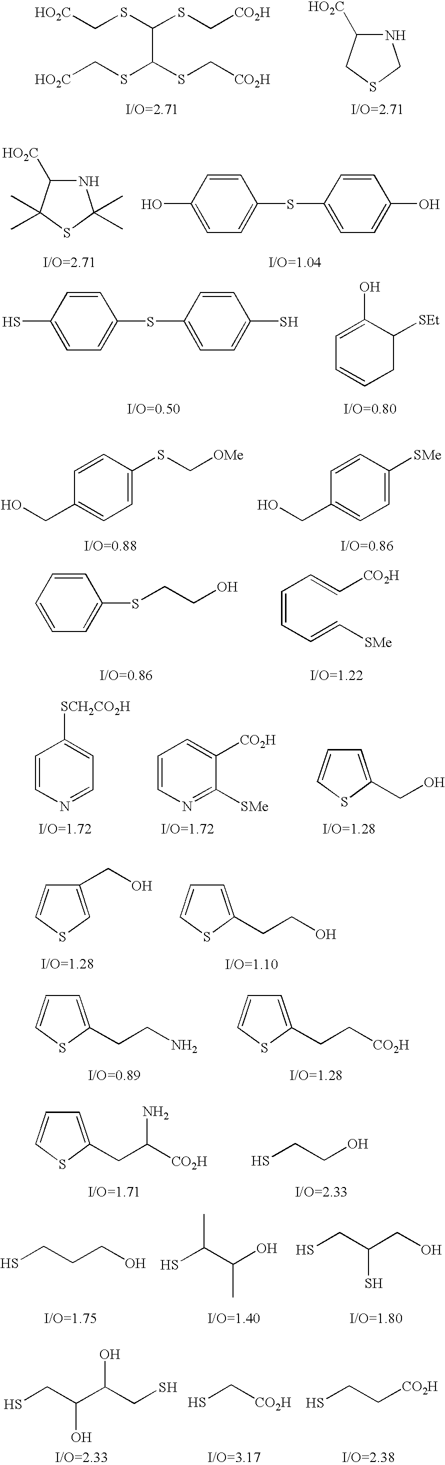

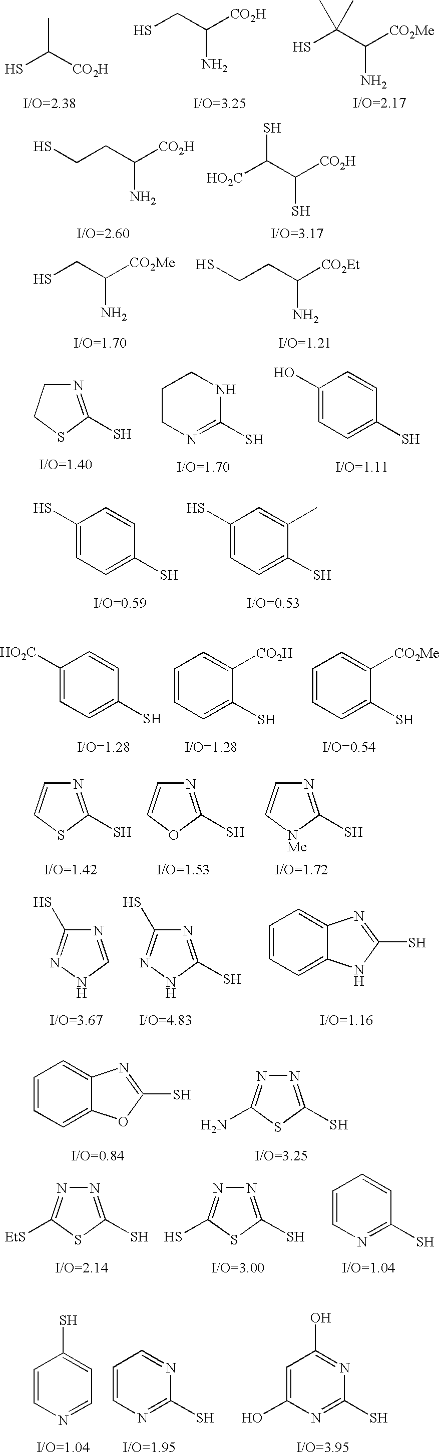

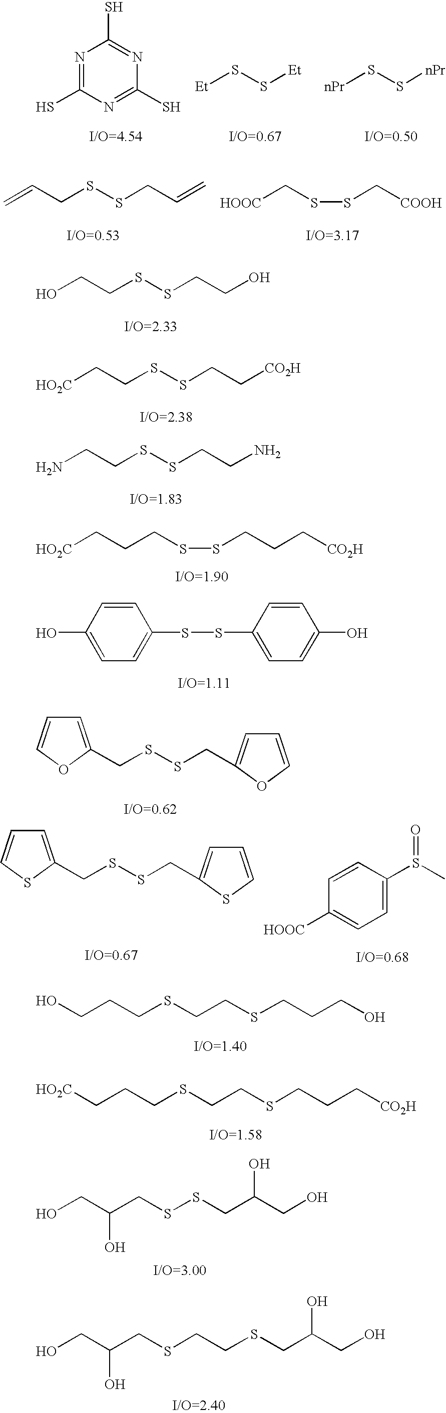

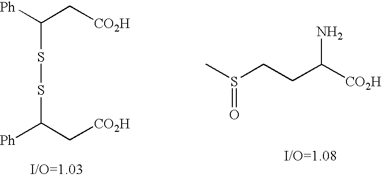

The inorganicity/organicity (I/O) ratios of the compounds represented by formulae (1) to (4) are preferably 0.50 or more, and more preferably 1.0 to 5.0.

In formula (5), X represents a hydroxyl group, a carboxyl group, a carboxylate, an amino group, or a group having at least one of these groups. Y¹, Y² and Y³ each independently represent an alkylene group, m represents an integer of 1 to 6, and m represents 0 or 1.

In formula (5), the alkylene group represented by Y¹, Y² and Y³ preferably has 1 to 12 carbon atoms, and more preferably 1 to 6 carbon atoms. Examples of such an alkylene group include methyl, ethylene, propylene, tetramethylene and hexamethylene groups.

Examples of the group having at least one of a hydroxyl group, a carboxyl group, a carboxylate and an amino group represented by X in formula (5) include —CH₂OH, —CH₂COOH, —CH₂NH₂, —CHOH—CH₂OH and CHNH₂COOH.

Examples of the thioether compound represented by formula (5) used for the ink-jet recording medium of the invention include some of the exemplified compounds represented by formulae (1) to (4), depending on the selection of X, Y¹, Y², Y³, n and m.

The I/O ratio of the compound represented by formula (5) is preferably 0.5 or more, and more preferably 1.0 to 5.0.

Among the compounds represented by formulae (1) to (5), the sulfur-containing compounds represented by formulae (1), (2), (4) and (5) are preferable, and the compounds represented by formulae (4) and (5) are particularly preferable. The number of the sulfur atoms in the molecule is preferably 1 to 6, and more preferably 1 to 3.

The sulfur-containing compound is preferably a high molecular compound having a molecular weight of 1,000 or more in view of stability of the fine particle dispersion solution and suppression of time-dependent blurring. The compound preferably has a thioether bond in view of ozone resistance, and in this case it is more preferable if the sulfur equivalent is 1.2 meq/g or more.

(Water-Soluble Resin)

The ink-receiving layer of the invention preferably has a porous structure, and the porous structure is preferably constituted of a water-soluble resin.

Examples of the water-soluble resin include polyvinyl alcohol resins that are resins having hydroxyl groups as the hydrophilic structural unit [such as polyvinyl alcohol (PVA), polyvinyl alcohol modified with acetoacetyl groups, polyvinyl alcohol modified with cationic groups, polyvinyl alcohol modified with anionic groups, polyvinyl alcohol modified with silanol groups, and polyvinyl acetal], cellulose resins [methyl cellulose (MC), ethyl cellulose (EC), hydroxyethyl cellulose (HEC), carboxymethyl cellulose (CMS), hydroxypropyl cellulose (HPC), hydroxyethylmethyl cellulose, and hydroxypropylmethyl cellulose], chitin, chitosan, starch, resins having ether bonds [such as polyethylene oxide (PEO), polypropylene oxide (PPO), polyethyleneglycol (PEG), and polyvinyl ether (PVE)], and resins having carbamoyl groups [such as polyacrylamide (PAAM), polyvinyl pyrrolidone (PVP), and polyacrylic acid hydrazide].

Resins having a carboxyl group as a dissociating group (polyacrylates), alginates, maleic acid resins and gelatin can also be used.

The polyvinyl alcohol resins are preferable among the above-described resins. Examples of the polyvinyl alcohol resins are described in Japanese Patent Application Publication (JP-B) Nos. 4-52786, 5-67432, 7-29479 and 7-57553; Japanese Patent Nos. 2,537,827, 2,502,998 3,053,231, 2,604,367 and 2,750,433; and JP-A Nos. 63-176173, 7-276787, 9-207425, 11-58941, 2000-135858, 2001-205924, 2001-287444, 62-278080, 9-39373, 2000-158801, 2001-213045, 2001-328345, 8-324105 and 11-348417.

Other examples of the water-soluble resin other than the polyvinyl alcohol resin include the compounds described in paragraph Nos. [0173] to [0174] in JP-A No. 11-165461. These water-soluble resins may be used alone, or as a combination of two or more thereof.

The polyvinyl alcohol resins may be used in combination with other water soluble resins. When the other water-soluble resins and polyvinyl alcohol resins are used in combination, the content of the polyvinyl alcohol resin in the total water-soluble resin composition is preferable no less than 50% by mass, and more preferably no less than 70% by mass.

The content of the water-soluble resin is preferably 9 to 40% by mass, and more preferably 12 to 33% by mass based on the mass of the total solid fraction of the ink-receiving layer.

(Particles)

The ink-receiving layer of the ink-jet recording medium of the invention preferably contains particles, and more preferably contains both the particles and water soluble resin. A porous structure is obtained by adding particles to the ink-receiving layer thereby improving ink absorbing property of the ink-receiving layer. In order to obtain a better porous structure, the content of the fine particles in the ink-receiving layer preferably exceeds 50% by mass, and more preferably exceeds 60% by mass based on the solid part of the ink-receiving layer, thereby providing an ink-jet recording medium having sufficient ink absorbing property. The content of the fine particles contained in the solid part of the ink-receiving layer refers to a content calculated based on the components except water in the composition consisting of the ink-receiving layer.

While organic and inorganic fine particles may be used as fine particles, the inorganic fine particles are preferable in view of ink absorbing property and image stability.

The organic fine particles are preferably polymer fine particles obtained by emulsion polymerization, micro-emulsion polymerization, soap-free polymerization, seed polymerization and suspension polymerization. Examples thereof include polymer fine particles as latex or emulsion of polyethylene, polypropylene, polystyrene, polyacrylate, polyamide, silicone resins, phenol resins and natural polymers.

Examples of the inorganic fine particles include silica fine particles, colloidal silica, titanium dioxide, barium sulfate, calcium silicate, zeolite, kaolinite, halloysite, mica, talk, calcium carbonate, magnesium carbonate, calcium sulfate, pseudo-boehmite, zinc oxide, zinc hydroxide, alumina, aluminosilicate, calcium silicate, magnesium silicate, zirconium oxide, zirconium hydroxide, cilium oxide, lanthanum oxide and ytterbium oxide. Silica fine particles, colloidal silica, alumina fine particles and pseudo-boehmite are preferable among them in view of forming a good porous structure. The fine particles may be directly used as primary particles, or by forming secondary particles. The average primary diameter of the fine particles is preferably not larger than 2 μm, and more preferably not larger than 200 nm.

Further preferable fine particles are silica fine particles with an average primary diameter of not larger than 20 nm, colloidal silica with an average primary diameter of not larger than 30 nm, alumina fine particles with an average primary diameter of not larger than 20 nm, or pseudo-boehmite with an average pore radius of 2 to 15 nm, and silica fine particles, alumina fine particles and pseudo-boehmite are particularly preferable.

The silica fine particles are roughly divided into particles obtained by wet process and particles obtained by dry process (fumed particles). In a typical method of the wet process, active silica is formed by acid decomposition of a silicate salt, and hydrated silica is obtained by sedimentation after appropriately polymerizing the particles. On the other hand, a typical method of the vapor phase process includes a method of high temperature vapor phase hydrolysis of silicone halide (flame hydrolysis), and a method for obtaining anhydrous silica by air-oxidation of a vaporized heat reduction product of silica sand and coke with an arc in an electric furnace. “Fumed silica” means anhydrous silica fine particles obtained by the vapor phase method. Fumed silica fine particles are preferable as the silica fine particles used in the invention.

While fumed silica has a different silanol group density and proportion of voids on the surface from those of hydrated silica, and exhibits different properties form those of hydrated silica, fumed silica is suitable for forming a three-dimensional structure with a high void ratio. Although the reason thereof is not clear, the density of the silanol group on the surface of the fine particles is as high as 5 to 8 per nm² in hydrated silica so that the silica fine particles tend to closely aggregate. On the other hand, the density of the silanol group on the surface of the fine particles is as small as 2 to 3 per nm² in fumed silica so that the silica fine particles tend to sparsely flocculate. Consequently, fumed silica is conjectured to afford a structure having high void ratio.

A particularly large specific surface area of fumed silica renders ink absorbing property and ink retention efficiency high, while low refraction index thereof affords transparency of the ink-receiving layer by dispersion of the fine particles to an appropriate particle diameter to give an advantage for obtaining high color density and good coloring. Transparency of the ink-receiving layer is important for obtaining a high color density and good luster of coloring in the application fields requiring transparency such as OHP as well as in applying to recording media such as photographic glossy paper.

The primary particle diameter of fumed silica is preferably not larger than 30 nm, more preferably not larger than 20 nm, still more preferably not larger than 10 nm, and most preferably 3 to 10 nm. Since fumed silica tends to be adhered with each other due to hydrogen bonds between the silanol groups, a structure having a large void ratio may be formed when the primary particle diameter is less than 30 nm to enable ink absorbing characteristics to be effectively improved.

If desired, the silica particles may be used in combination with the above-mentioned other particles. In the case where the fumed silica is used in combination with other particles, the content of the fumed silica contained in all the particles present in the layer is preferably at least 30% by weight, and more preferably at least 50% by weight.

Other examples of inorganic particles to be used in the invention include alumina particles, alumina hydrate and their mixtures or composites. Among them, alumina hydrate is preferable since it well absorbs and fixes ink, and pseudo-boehmite (Al₂O₃.nH₂O) is more preferable. The alumina hydrate of any morphology may be used herein, and sol-formed boehmite is particularly preferably used since it forms a smooth layer.

Regarding the microstructure of pseudo-boehmite used herein, the mean pore radius thereof is preferably from 1 to 30 nm, and more preferably from 2 to 15 nm. The pore volume thereof is preferably from 0.3 to 2.0 ml/g (cc/g), and more preferably from 0.5 to 1.5 ml/g (cc/g). The pore radius and the pore volume are measured by a nitrogen adsorption/desorption method, using, for example, a gas adsorption/desorption analyzer (e.g., Coulter's trade name, OMNISORP 369).

In particular, fumed alumina particles are preferably used due to their large specific surface area. The fumed alumina particles preferably have an average primary particle diameter of at most 30 nm, and more preferably at most 20 nm.

The above-mentioned particles may be used in the inkjet recording sheet in the embodiments disclosed in JP-A 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777 and 2001-301314.

The fine particles mainly constituting the porous structure of the ink-receiving layer of the invention may comprise single material or may be a mixed material of plural materials.

The selection of the water-soluble resin used in combination with the fine particles, particularly silica fine particles, is important in view of maintaining transparency. Polyvinyl alcohol resins are preferable as the water soluble resin when fumed silica is used. The polyvinyl alcohol resin preferably has a degree of saponification of 70 to 100%, and particularly preferably 80 to 99.5%.

While the polyvinyl alcohol resin has a hydroxyl group in its structural unit, a three-dimensional network structure is readily formed using network chain units of the secondary silica fine particles, since the hydroxyl group forms a hydrogen bond with the silanol group on the surface of the silica fine particles. The ink-receiving layer having a high void ratio and sufficient strength is considered to be formed by forming the three-dimensional network structure.

The ink-receiving layer obtained in the above-described manner rapidly absorbs ink by a capillary phenomenon during ink-jet recording, and ink dots having good circularity can be formed without blurring of ink.

(Content Ratio of Fine Particles and Water-Soluble Resin)

The mass content ratio [PB ratio(x:y)] between the content (x) of the fine particles and the content (y) of the water soluble resin largely affects the film structure and film strength of the ink-receiving layer. In other words, when the mass content ratio (PB ratio) is larger, the void ratio, pore volume and surface area (per unit mass) tend to increase, but the density and strength tend to decrease.

The mass content ratio [PB ratio (x:y)] is preferably in a range of 1.5:1 to 10:1 in the ink-receiving layer of the invention for preventing a decrease of the film strength and generation of cracks by drying ascribed to a too large PB value, and for preventing void blocking tendency of the resin and decrease of ink absorbing property due to the decrease of the void ratio.

Since the recording medium receives stress when the recording medium is transferred through a convey system of an ink-jet printer, the ink-receiving layer is required to have a sufficient film strength. The ink-receiving layer is also required to have a sufficient film strength for preventing the ink-receiving layer from being cracked and peeled when the recording medium is subjected to a cutting process. In view of the above-described situations, the mass ratio (x:y) is further preferably 5:1 or less. The ratio is preferably 2:1 or more for ensuring high speed ink absorption during the operation of the ink-jet printer.

For example, the three-dimensional network structure comprising network chains of the secondary fine silica fine particles is formed by applying a coating solution prepared by completely dispersing the fumed silica fine particles with an average primary particle diameter of not larger than 20 nm in an aqueous solution of the water soluble resin with a mass ratio (x:y) in a range of 2:1 to 5:1 followed by drying the coating layer. A transparent porous film with an average pore diameter of not larger than 30 nm, a void ratio of 50 to 80%, a void specific volume of 0.5 ml/g or more and a specific surface area of 100 m²/g or more may be readily formed by the above-described process.

(Crosslinking Agent)

In the ink-receiving layer of the invention, the coating layer comprising the water-soluble resin preferably further comprises a crosslinking agent capable of crosslinking the water-soluble resin. Particularly in an embodiment in which the fine particles and the water-soluble resin are used in combination, the water-soluble resin is preferably cross-linked by the crosslinking agent to form a cured porous structure.

A boron compound is preferable for crosslinking of the water-soluble resin, especially for crosslinking of polyvinyl alcohol. Examples of the boron compound include borax, boric acids, borates (e.g., orthoborates, InBO₃, ScBO₃, YBO3, LaBO₃, Mg₃(BO₃)₂, CO₃(BO₃)₂), diborates (e.g., Mg₂B₂O₅, CO₂B₂O₅), metaborates (e.g., LiBO₂, Ca(BO₂)₂, NaBO₂, KBO₂), tetraborates (e.g., Na₂B₄O₇.10H₂O), pentaborates (e.g., KB₅O₈.4H₂O, Ca₂B₆O₁₁.7H₂O, CsB₅O₅). Among them, borax, boric acids and borates are preferable since they are capable of rapidly starting a crosslinking reaction, and further boric acids are particularly preferable.

Other compounds may also be used as a crosslinking agent for the water soluble resin besides boron compounds. Examples of such compounds include aldehyde compounds such as formaldehyde, glyoxal and glutaraldehyde; ketone compounds such as diacetyl and cyclopentanedione; active halogen compounds such as bis(2-chloroethylurea)-2-hydroxy-4,6-dichloro-1,3,5-triazine and 2,4-dichloro-6-S-triazine sodium; active vinyl compounds such as divinylsulfonic acid, 1,3-vinylsulfonyl-2-propanol, N,N′-ethylenebis(vinylsulfonylacetamide) and 1,2,5-triacryloyl-hexahydro-5-triazine; N-methylol compounds such as dimethylolurea and methyloldimethyl hydantoin; melamine resins (for example methylolmelemine and alkylated methylolmelemine; epoxy resins; isocyanate compounds such as 1,6-hexamethylene diisocyanate; carboxyimide compounds described in U.S. Pat. Nos. 3,017,280 and 2,983,611; epoxy compounds such as glycerol triglycidylether; ethylenimino compounds such as 1,6-hexamethylene-N,N′-bisethyleneurea; halogenated carboxyaldehyde compounds such as mucochloric acid and phenoxychloric acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compound such as hydrazide adipate; and low molecular weight compounds or polymers having at least two oxazoline groups.

The crosslinking compound may be used alone, or in combination of two or more thereof. The amount of the crosslinking compound to be used is preferably 1 to 50% by mass, and more preferably 5 to 40% by mass, based on the mass of the water-soluble resin.

In the invention, the water-soluble resin is preferably cured by crosslinking in the following manner. A crosslinking agent is added to a coating solution containing at least the water-soluble resin and the at least two kinds of the cationic organic polymers (hereinafter, sometimes referred to as “coating liquid A”) and/or a basic solution having a pH of 7.1 or more (hereinafter, sometimes referred to as “coating liquid B”). The basic solution having a pH of 7.1 or more (coating liquid B) is applied to the coating layer either (1) simultaneously with the formation of the coating layer by application of the coating liquid or (2) during drying of the coating layer formed by application of the coating liquid and before the coating layer exhibits a decreasing rate of drying so as to cure the coating layer.

The application of the crosslinking agent will be specifically explained by using boron compound as an example as follows. When the ink-receiving layer is formed by crosslinking and curing the coating layer of the coating liquid (coating liquid A) comprising the water soluble resin (polyvinyl alcohol) and at least two cationic organic polymers, a basic solution having a pH of 7.1 or more (coating solution B) is preferably applied onto the coating layer either (1) simultaneously with formation of the coating layer by application of the coating liquid or (2) during drying of the coating layer formed by application of the coating liquid and before the coating layer exhibits a decreasing rate of drying so as to cure the coating layer. The boron compound as the crosslinking agent may be contained in either coating solution A or coating solution B, or may be contained in both coating solutions A and B.

(Mordants)

Polymer mordants other than the cationic polymer (for example, polymers containing quaternary ammonium salts) and inorganic mordants (hereinafter, collectively referred to as “other mordants”) may be used in combination with the cationic polymer in the ink-receiving layer of the invention for improving water resistance and time-dependent blurring of the image formed. Either the organic mordant or the inorganic mordant may be used alone, or the organic mordant and inorganic mordant may be used in combination.

When the cationic polymers of the invention and other mordant are used in combination, the proportion between them may be determined considering the balance between storability and time-dependent blurring. The content of the cationic polymers of the invention is preferably no less than 10%, and more preferably no less than 20%, based on the mass of the mordant to be used.

When the mordant including the cationic polymer of the invention is added to the ink-receiving layer, the mordant may be added to coating solution A comprising the fine particles and the water soluble resin, or to coating solution B before application when there is a possibility of the fine particles being coagulated by adding the mordants.

Specific examples of the polymer mordants used in combination with the cationic polymer of the invention are described in JP-A Nos. 48-28325, 54-74430, 54-124726, 55-122766, 55-142339, 60-23850, 60-23851, 60-23852, 60-23853, 60-57836, 60-60643, 60-118834, 60-122940, 60-122941, 60-122942, 60-235134, 1-161236, 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, 2001-301314, 7-118333 and 2000-344990; U.S. Pat. Nos. 2,484,430, 2,548,564, 3,148,061, 3,309,690, 4,115, 124, 4,124,386, 4,193,800, 4,273,853, 4,282,305 and 4,450,224; JP-A Nos. 5-35162, 5-35163, 5-35164 and 5-88846; and Japanese Patent Nos. 2,648,847 and 2,661,677.

Examples of the inorganic mordant used in combination with the cationic polymer of the invention include water soluble polyvalent metal salts and hydrophobic metal salt compounds.

Specific examples of the inorganic mordant include salts or complexes of metals selected from magnesium, aluminum, calcium, scandium, titanium, vanadium, manganese, iron, nickel, copper, zinc, gallium, germanium, strontium, ytterbium, zirconium, molybdenum, indium, barium, lanthanum, cilium, praseodymium, neodymium, samarium, europium, gadolinium, dysprosium, erbium, ytterbium, hafnium, tungsten and bismuth.

Concrete example of such inorganic mordant include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, copper(II)ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminium sulfate, aluminium alum, aluminium chloro hydrate, aluminium sulfite, aluminium thiosulfate, aluminium sesquichloro hydrate, aluminium nitrate 9-hydrate, aluminium chloride hexahydrate, basic aluminium lactate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, ammonium zirconium carbonate, zirconyl lactate, zirconyl succinate, zirconyl oxalate, zirconyl stearate, zirconyl octylate, zirconyl nitrate, ammonium zirconium acetate, potassium zirconium carbonate, sodium zirconium lactate, basic zirconium glycinate, basic aluminium sulfate, basic aluminium nitrate, basic aluminium sulfamate, basic aluminium formate, basic aluminium acetate, basic aluminium glycinate, zirconium oxychloride, zirconium hydroxychloride, chromium acetate, chromium sulfate, magnesium sulfate, magnesium chloride hexahydrate, magnesium citrate 9-hydrate, sodium phosphotungstate, sodium tungsten citrate, 12-tungstophosphoric acid n-hydrate, 12-tungstosilicic acid 26-hydrate, molybdenum chloride, 12-molybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, etc.

Preferable inorganic mordants used in the invention are aluminum-containing compounds, titanium-containing compounds, zirconium-containing compounds and group IIIB metal compounds in the periodic table (salts and complexes), and particularly preferable compounds are aluminum-containing compounds and titanium-containing compounds.

Preferable examples of the aluminum-containing compounds include water-soluble aluminum compounds (such as aluminum sulfate, aluminum alum, basic polyaluminum hydroxide, aluminum sulfite, aluminum thiosulfate, polyaluminum chloride, aluminum nitrate nonahydrate and aluminum chloride hexahydrate). Preferable examples of the zirconium-containing compounds include water-soluble zirconium compounds (such as zirconyl acetate, zirconium sulfate, zircoammonium carbonate, zirconium nitrate, zirconium oxychloride and zirconium hydroxychloride). Among them, basic polyaluminum hydroxide is particularly preferable.

The total content of the mordant contained in the ink-receiving layer of the invention is preferably 0.01 to 5 g/m², and more preferably 0.1 to 3 g/m². When an inorganic mordant and an organic mordant are used in combination, the ratio between them may be determined considering the balance between storability and blurring. The proportion of the inorganic mordant in the total mordant is preferably 5% or more, and more preferably 10% or more.

(Other Components)

The ink-jet recording medium of the invention may comprise various known additives, if necessary, such as acids, UV absorbing agent, antioxidant, fluorescent whitening agent, monomers, polymerization initiator, polymerization preventive agent, blurring preventive agent, antiseptic, viscosity stabilizing agent, anti-foaming agent, surfactant, anti-static agent, mat agent, curl preventive agent and water resistance agent.

The ink-receiving layer of the invention may contain an acid. The surface pH of the ink-receiving layer is adjusted to pH 3 to 8, preferably pH 5 to 7.5, by adding the acid in order to improve yellowing resistance of the white background. The surface pH is measured by method A (coating method) of the surface pH measuring methods prescribed by Japanese Paper and Pulp Technology Association (J. TAPPI). For example, the pH is measured using a paper pH measuring set “Type MPC” manufactured by Kyoritsu Chemical-Check Laboratory, Co.

Specific examples of the acid include formic acid, acetic acid, glycolic acid, oxalic acid, propionic acid, malonic acid, citric acid, adipic acid, maleic acid, malic acid, tartaric acid, citric acid, benzoic acid, phthalic acid, isophthalic acid, glutaric acid, glucuronic acid, lactic acid, aspartic acid, glutamic acid, salicylic acid, salicylic acid metal salts (such as Zn, Al, Ca, Mg salts), methanesulfonic acid, itaconic acid, benzenesulfonic acid, toluenesulfonic acid, trifluoromethane sulfonic acid, styrene sulfonic acid, trifluoroacetic acid, barbituric acid, acrylic acid, methacrylic acid, cinnamic acid, 4-hydroxybenzoic acid, aminobenzoic acid, naphthalene sulfonic acid, hydroxybenzene sulfonic acid, toluenesulfinic acid, benzenesulfinic acid, sulfanilic acid, sulfamic acid, α-resorcylic acid, β-resorcylic acid, γ-resorcylic acid, gallic acid, phloroglucine, sulfosalicylic acid, ascorbic acid, erythorbic acid, bisphenolic acid, hydrochloric acid, nitric acid, sulfuric acid, phosphoric acid, polyphosphoric acid, boric acid and boronic acid. Such an acid may be added so that the surface pH of the ink-receiving layer becomes 3 to 8.

These acids may be used as metal salts (for example sodium, potassium, calcium, cesium, zinc, copper, aluminum, zirconium, lanthanum, ytterbium, magnesium, strontium and cilium salts) or amine salts (for example ammonium, triethylamine, tributylamine, piperazine, 2-methylpiperazine and polyallyl amine salts).

The ink-receiving layer may contain storability improving agents such as UV absorbing agent, antioxidant and blurring preventive agent.

Examples of the UV absorbing agent, antioxidant and blurring preventive agent include alkylphenol compounds (including hindered alkylphenol compounds), alkylthiomethyl phenol compounds, hydroquinone compounds, alkylhydroquinone compounds, tocopherol compounds, thiodiphenyl ether compounds, compounds having at least two thioether bonds, bisphenol compounds, O-, N- and S-benzyl compounds, triazine compounds, phosphonate compounds, acylaminophenol compounds, ester compounds, amide compounds, ascorbic acid, amine antioxidants, 2-(2-hydroxyphenyl)benzotriazole compounds, 2-hydroxybenzophenone compounds, acrylates, water-soluble or hydrophobic metal salts, organic metal salts, hindered amine compounds (including TEMPO), 2-(2-hydroxyphenyl)-1,3,5-triazine compounds, metal inactivating compounds, phosphite compounds, phosphonite compounds, hydroxylamine compounds, nitrone compounds, peroxide scavengers, polyamide stabilizers, polyether compounds, basic auxiliary stabilizers, nucleating agents, benzofuranone compounds, indolinone compounds, phosphine compounds, polyamine compounds, thiourea compounds, urea compounds, hydrazide compounds, amidine compounds, sugar compounds, hydroxybenzoic acid compounds, dihydroxybenzoic acid compounds and trihydroxybenzoic acid compounds.

Among them, alkylphenol compounds, compounds having at least two thioether bonds, bisphenol compounds, ascorbic acid, amine antioxidants, water-soluble or hydrophobic metal salts, organic metal compounds, metal complexes, hindered amine compounds, hydroxylamine compounds, polyamine compounds, thiourea compounds, hydrazide compounds, hydroxybenzoic acid compounds, dihydroxybenzoic acid compounds and trihydroxybenzoic acid compounds are preferably used.

Specific examples of the compounds include those described in JP-A Nos. 2002-307822, 10-182621, 2001-260519, 11-170686, 60-67190, 7-276808, 2001-94829, 47-10537, 58-111924, 58-212844, 59-19945, 59-46646, 59-109055 and 63-53544; JP-B Nos. 4-34953, 4-34513, 4-34512, 36-10466, 42-26187, 48-30492, 48-31255, 48-41572, 48-54965 and 50-10726; EP No. 1,138,509; and U.S. Pat. Nos. 2,719,086, 3,707,375, 3,754,919 and 4,220,711; JP-B Nos. 45-4699, 54-5324; EP 223739, 309401, 309402, 310, 551, 310552 and 459,416; GP 3,435,443; JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381 and 63-113536; JP-A Nos. 63-163351, 63-203372, 63-114989, 63-251282, 63-267594, 63-182484, 1-239282, 2-262654, 2-71262, 3-121449, 4-291685, 4-291684, 5-61166, 5-11944, 5-188687, 5-188686, 5-110490, 5-1108437 and 5-170361; JP-B Nos. 48-43295 and 48-33212; and U.S. Pat. Nos. 4,814,262 and 4,980,275.

The other components may be used alone, or in combination of two or more. The other components may be added by dissolving in water, by dispersing in the solution, by dispersing in a polymer, by emulsification or as oil drops, or may be incorporated into capsules. The amount of the other components to be added is preferably 0.01 to 10 g/m².

For increasing the dispersibility of inorganic particles, their surfaces may be processed with a silane coupling agent. Preferably, the silane coupling agent has an organic functional group (e.g., vinyl group, amino group (primary to tertiary amino group, quaternary ammonium salt group), epoxy group, mercapto group, chloride group, alkyl group, phenyl group and ester group), in addition to the coupling-active site.

The coating liquid for the ink-receiving layer of the invention preferably contains a surfactant. The surfactant may be any of nonionic, ampholytic, anionic, cationic, fluorine-containing or silicon-containing surfactants.

Examples of the nonionic surfactant include polyoxyalkylene alkyl ethers and polyoxyalkylene alkylphenyl ethers (e.g., diethylene glycol monoethyl ether, diethylene glycol diethyl ether, polyoxyethylene lauryl ether, polyoxyethylene stearyl ether, polyoxyethylene nonylphenyl ether), oxyethylene-oxypropylene block copolymers, sorbitan fatty acid esters (e.g., sorbitan monolaurate, sorbitan monooleate, sorbitan trioleate), polyoxyethylene-sorbitan fatty acid esters (e.g., polyoxyethylene-sorbitan monolaurate, polyoxyethylene-sorbitan monooleate, polyoxyethylene-sorbitan trioleate), polyoxyethylene-sorbitol fatty acid esters (e.g., polyoxyethylene-sorbitol tetraoleate), glycerin fatty acid esters (e.g., glycerol monooleate), polyoxyethylene-glycerin fatty acid esters (e.g., polyoxyethylene-glycerin monostearate, polyoxyethylene-glycerin monooleate), polyoxyethylene fatty acid esters (e.g., polyethylene glycol monolaurate, polyoxyethylene glycol monooleate), polyoxyethylene alkylamines, acetylene glycols (e.g., 2,4,7,9-tetramethyl-5-decyne-4,7-diol, and ethylene oxide adducts and propylene oxide adducts to the diol). Among them, polyoxyalkylene alkyl ethers are particularly preferable. The nonionic surfactant may be added to the first or second coating liquids. These nonionic surfactants may be used alone, or in combination of two or more.

Examples of the ampholytic surfactant include amino acid-type, carboxyammonium betaine-type, sulfonammonium betaine-type, ammonium sulfate betaine-type and imidazolium betaine-type compounds. For example, those described in U.S. Pat. No. 3,843,368, JP-A Nos. 59-49535, 63-236546, 5-303205, 8-262742, 10-282619, Japanese Patent Nos. 2,514,194, 2,759,795, and JP-A No. 2000-351269 are preferably used. Among the ampholytic surfactants, amino acid-type, carboxyammonium betaine-type and sulfonammonium betaine-type compounds are more preferable. Such ampholytic surfactants may be used alone, or in combination of two or more.

Examples of the anionic surfactant include salts of fatty acid (e.g., sodium stearate, potassium oleate), salts of alkylsulfates (e.g., sodium laurylsulfate, laurylsulfate triethanolamine), salts of sulfonic acids (e.g., sodium dodecylbenzenesulfonate), salts of alkylsulfosuccinates (e.g., sodium dioctylsulfosuccinate), salts of alkyldiphenyl ether disulfonates and salts of alkylphosphates.

Examples of the cationic surfactant include alkylamine salts, quaternary ammonium salts, pyridinium salts and imidazolium salts.

The fluorine-containing surfactant may be a compound derived from a perfluoroalkyl group-having intermediate through electrolytic fluorination, telomerization or oligomerization. Examples of such a compound include salts of perfluoroalkylsulfonates, salts of perfluoroalkylcarboxylic acids, perfluoroalkyl-ethylene oxide adducts, perfluoroalkyl-trialkylammonium salts, perfluoroalkyl group-having oligomers and perfluoroalkylphosphates.

As a silicon-containing surfactant, silicone oil modified with an organic group can be preferably used. Such a silicone oil may take a structure in which a side branch of the siloxane structure is modified with an organic group; or both terminals or one terminal is modified with an organic group. The organic group modification includes, for example, amino modification, polyether modification, epoxy modification, carboxyl modification, carbinol modification, alkyl modification, aralkyl modification, phenol modification and fluorine modification.

The content of the surfactant is preferably 0.001 to 2.0% by mass, and more preferably 0.01 to 1.0% by mass based on the mass of the coating solution of the ink-receiving layer. When at least two liquids are used as the coating liquids for applying the ink-receiving layer, the surfactant is preferably added in each coating liquid.

The ink-receiving layer of the invention preferably contains a high boiling point organic solvent for preventing curling. The high boiling point organic solvent is an organic compound having a boiling temperature of 150° C. or more under an atmospheric pressure. These compounds may be a liquid or solid at room temperature, and may be either a low molecular weight or a high molecular weight compound.

Specific examples of the high boiling point organic solvent include aromatic carboxylic acid esters (for example dibutyl phthalate, dipehnyl phthalate and phenyl benzoate), aliphatic carboxylic acid esters (for example dioctyl adipate, dibutyl sebacate, methyl stearate, dibutyl maleate, dibutyl fumarate and triethyl acetylcitrate), phosphoric acid esters (for example trioctyl phosphate and tricresyl phosphate), epoxy compounds (for example epoxylated soy bean oil and epoxylated fatty acid methyl esters), alcohols (for example stearyl alcohol, ethyleneglycol, propyleneglycol, diethyleneglycol, triethyleneglycol, glycerin, diethyleneglycol monobutylether (DEGMBE), triethyleneglycol monobutylether, glycerin monomethylether, 1,2,3-butanetriol, 1,2,4-buanetriol, 1,2,4-pentanetriol, 1,2,6-hexanetriol, thiodiglycol, triethanolamine and polyethyleneglycol), plant oils (for example soy bean oil and sunflower oil), and higher fatty acids (for example linoleic acid and oleic acid).

(Substrate)

The substrate used for the ink-jet recording medium of the invention may be any one of transparent substrates comprising transparent materials such as plastics and opaque substrates comprising opaque materials such as paper. The transparent substrate or a highly glossy opaque substrate is preferably used for taking advantage of transparency of the ink-receiving layer.

Material that can be used for the transparent substrate is preferably a transparent material that is durable to radiation when it is used in OHP and backlight display. Examples of the preferable material include polyesters such as polyethylene terephthalate (PET), polysulfone, polyphenylene oxide, polyimide, polycarbonate and polyamide. Polyesters are preferable among them, and polyethylene terephthalate is particularly preferable.

While the thickness of the transparent substrate is not particularly limited, it is preferably 50 to 200 μm in view of handling easiness.

The glossy opaque substrate preferably has glossiness of no less than 40% on the surface at the side for providing the ink-receiving layer. Glossiness is determined according to JIS P-8142 (specular glossiness test method at 75° for paper and paper board). Specific examples of the substrate are described below.

Examples of a glossy opaque substrate include paper supports having high glossiness, such as art paper, coated paper, cast-coated paper, or baryta paper for silver-salt photographic supports; glossy plastic films of polyesters such as polyethylene terephthalate (PET), cellulose esters such as nitrocellulose, cellulose acetate or cellulose acetate butyrate, polysulfones, polyphenylene oxides, polyimides, polycarbonates or polyamides, which are made opaque by adding a white pigment thereto (their surface may be calendered); and supports prepared by coating the above-mentioned various types of paper supports, transparent supports or white pigment-containing films of high glossiness, with a polyolefin layer containing or not containing a white pigment.

White pigment-containing foamed polyester films (for example, foamed PET containing polyolefin particles and stretched to form pores therein) are also preferably used. In addition, resin-coated paper for silver-salt photographic printing paper is also preferable.

There is no particular limitation on the thickness of the opaque support, but the thickness is preferably from 50 to 300 μm in view of handling easiness.

The supports may be treated with corona discharge, glow discharge, flames, or UV irradiation for improving the wettability and the adhesiveness thereof.

The base paper used for resin-coated paper is described in detail.

The main material of the base paper can be wood pulp. Synthetic pulp of polypropylene or synthetic fiber of nylon or polyester is optionally added to wood pulp, and this is made into paper. The wood pulp may be any of LBKP, LBSP, NBKP, NBSP, LDP, NDP, LUKP or NUKP, but it is desirable to use a larger amount of LBKP, NBSP LBSP, NDP or LDP containing much short fiber.

The proportion of LBSP and/or LDP is preferably from 10 to 70% by mass.

The pulp is preferably chemical pulp (sulfate pulp or sulfite pulp) containing few impurities, and it may be bleached to have an increased degree of whiteness. The bleached pulp is also useful herein.

A sizing agent such as higher fatty acids, alkylketene dimers; a white pigment such as calcium carbonate, talc, titanium oxide; a paper reinforcing agent such as starch, polyacrylamide, polyvinyl alcohol; a fluorescent brightener; a water-retaining agent such as polyethylene glycols; a dispersant; and a softener such as quaternary ammoniums may be optionally added to the base paper.

The freeness of the pulp to be made into the base paper is preferably from 200 to 500 ml in terms of CSF. Regarding the fiber length of the pulp after beaten, it is desirable that the total of the 24-mesh residue and the 42-mesh residue defined in JIS P-8207 is from 30 to 70% by weight. Also preferably, the 4-mesh residue is at most 20% by weight.

The grammage of the base sheet is preferably 30 to 250 g, and particularly preferably 50 to 200 g. The thickness of the base sheet is preferably 40 to 250 μm. The base sheet may be processed to have high smoothness by calender processing during the paper making process of after the paper making process. The density of the base sheet is usually 0.7 to 1.2 g/m² (JIS P-8118).

Rigidity of the base sheet is preferably 20 to 200 g as measured under a condition prescribed in JIS P-8143.

A surface sizing agent may be applied on the surface of the base sheet, and the same sizing agent added in the base sheet may be used.

pH of the base sheet is preferably 5 to 9 as measured by a hot water extraction method according to JIS P-8113.

While polyethylene for coating the surface and back-face of the base sheet is mainly low density polyethylene (LDPE) or high density polyethylene (HDPE), LLDPE and polypropylene may be partly used.

The polyethylene layer at the side for forming the ink-receiving layer is preferably improved in opaqueness, whiteness and hue by adding titanium oxide of rutile or anatase type, fluorescent whitening agent and ultramarine which are widely used in photographic printing paper. The content of titanium oxide is preferably 3 to 20% by mass, and more preferably 4 to 13% by mass, based on the mass of polyethylene. While the thickness of the polyethylene layer is not particularly limited, a thickness of 10 to 50 μm is preferable on both the surface and back-surface. An undercoat layer may be provided for tightly adhering the ink-receiving layer on the polyethylene layer. Water-soluble polyester, gelatin and PVA are preferable as the undercoat layer. The thickness of the undercoat layer is preferably 0.01 to 5 μm.

The polyethylene-coated paper may be used as glossy paper, or by forming a mat surface or silky surface as used in conventional photographic printing paper by applying so-called patterning when polyethylene is coated on the surface of the base sheet by extrusion molding.

A back-coat layer may be provided on the substrate. Components capable of adding to the back-coat layer include white pigments, water-soluble binder and other components.

Examples of the white pigment contained in the back-coat layer include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, alumina, litpon, zeolite, hydrated halloysite, magnesium carbonate and magnesium; and organic pigments such as hydroxide; styrene plastic pigments, acrylic plastic pigments, polyethylene, microcapsules, urea resin and melamine resin.

Examples of the water-soluble binder used for the back-coat layer include water-soluble polymer such as styrene-maleate copolymer, styrene-acrylate copolymer, polyvinyl alcohol, silanol-modified polyvinyl alcohol, starch, cationic starch, casein, gelatin, carboxymethyl cellulose, hydroxyethyl cellulose and polyvinyl pyrrolidone; and water-dispersible polymers such as styrene-butadiene latex and acrylic emulsion.

Examples of other components that may be contained in the back-coat layer include defoaming agent, foam-suppressing agent, dyes, fluorescent whitening agents, antiseptics and water resistance agent.

(Production of Ink-Jet Recording Medium)

A preferable method for producing an ink-receiving layer of the ink-jet recording medium of the invention comprises: applying a coating liquid (coating liquid A) containing at least fine particles, water soluble resin, and the above-described two or more kinds of cationic organic polymers onto the surface of the substrate; applying a basic solution (coating liquid B) having a pH of 7.1 or more onto the coating layer either (1) simultaneously with formation of the coating layer by application of the coating liquid or (2) during drying of the coating layer formed by application of the coating liquid and before the coating layer exhibits a decreasing rate of drying so as to cure the coating layer; and curing the coating layer to which the basic solution has been applied by crosslinking (referred to Wet-on-Wet method, or WOW method, hereinafter). The cationic polymer of the invention may be added in either coating liquid A or coating liquid B, but the polymer is preferably added in coating liquid B in view of preventing the fine particles from being aggregated, and so forth. The crosslinking agent may be added in at least one of coating liquids A and B, preferably in coating liquid B.

It becomes possible to improve ink absorbing property and crack preventive property of the film by providing the ink-receiving layer cured by crosslinking in this manner.

When the ink-receiving layer is formed by using WOW method, more mordant (including the cationic polymers of the invention) tends to be distributed in the vicinity of the surface of the ink-receiving layer so that ink-jet colorants (ink) are sufficiently mordanted, and water resistance of letters and images after printing is improved, which is preferable. A part of the mordant may be added in coating liquid A, and the mordants in coating liquid A and coating liquid B may be the same or different. The porous ink-receiving layer obtained as described above is able to rapidly absorb the ink by capillary phenomenon to enable dots with good circularity to be formed without blurring of ink.

The coating liquid (coating liquid A) containing at least the fine particles (for example fumed silica) and water-soluble resin (for example polyvinyl alcohol) can be prepared as follows.

The fumed silica fine particles and a dispersing agent are added in water (for example, a fumed silica content is 10 to 20% by mass in water), and the mixture is dispersed at a high speed rotation of, for example, 10,000 rpm (preferably 5,000 to 20,000 rpm) for 20 minutes (preferably for 10 to 30 minutes) using a high speed rotation wet colloid mill (for example, trade name Clear Mix, manufactured by M-technique Co.). Subsequently, a crosslinking agent (boron compound) and a polyvinyl alcohol (PVA) aqueous solution are added (so that the mass ratio of PVA is 1/3 of fumed silica, for example), and a coating liquid is obtained by dispersing under the same condition as described above. The coating liquid obtained is a uniform sol, and the porous ink-receiving layer having a three-dimensional network structure can be formed by applying on the substrate by the coating method below followed by drying.

A water dispersion comprising fumed silica and dispersing agent may be prepared by either preparing an aqueous fumed silica dispersion in advance followed by adding the aqueous dispersion into an aqueous solution of the dispersing agent, by adding the an aqueous solution of the dispersing agent into the aqueous fumed silica dispersion, or by simultaneously adding both solutions. A powder of fumed silica in place of the aqueous fume silica dispersion may be added in the aqueous dispersion.

After mixing the fumed silica with the dispersing agent, the mixed liquid is finely granulated with a disperser to obtain an aqueous dispersion of fumed silica with an average diameter of 50 to 300 nm. While the disperser used for obtaining the aqueous dispersion solution include conventional dispersers such as a high speed rotation disperser, a medium stirring disperser (such as a ball mill and sand mill), ultrasonic disperser and high pressure disperser, the stirring disperser and colloid mill disperser are preferable for efficiently dispersing flocs of fine particles formed.

The cationic polymer, which is exemplified as the above-mentioned mordant, may be used as the dispersing agent. A silane coupling agent is also preferably used as the dispersing agent.

The amount of addition of the dispersing agent to the fine particles is preferably 0.1 to 30%, and more preferably 1 to 10%.

Water, organic solvents, or mixed solvents thereof may be used as a solvent in each step. Examples of the organic solvent used for coating include alcohols such as methanol, ethanol, n-propanol, i-propanol and methoxypropanol, ketones such as acetone and methylethyl ketone, tetrahydrofuran, acetonitrile, ethyl acetate and toluene.

The coating liquid for the ink-receiving layer may be applied by known methods using, for example, extrusion die coater, air doctor coater, bread coater, rod coater, knife coater, squeeze coater, reverse roll coater and bar coater.

The basic solution (coating liquid B) having a pH of 7.1 may be applied onto the coating layer simultaneously with or after applying the coating liquid (coating liquid A) of the ink-receiving layer. The basic solution (coating liquid B) may be applied before the coating layer exhibits a decreasing rate of drying. In other words, after applying the coating liquid (coating liquid A) to form a coating layer of the ink-receiving layer, the basic solution (coating liquid B) may be applied to the coating layer before this coating layer exhibits a constant rate of drying, thereby forming the ink-receiving layer.

The basic solution (coating liquid B) having a pH of 7.1 or more may comprise a crosslinking agent and a mordant, if necessary. The pH of the basic solution is preferably 7.3 or more, and more preferably 7.6 or more. When the pH of the basic solution is less than 7.1, the crosslinking reaction of the water-soluble polymer contained in coating liquid A by the crosslinking agent is insufficient, thereby causing defects such as cracks in the ink-receiving layer.

The basic solution (coating liquid B) may comprise at least a basic substance (for example ammonia, primary amines (such as ethylamine and polyallyamine), secondary amines (such as dimethylamine and diethylamine), tertiary amines (such as N-ethyl-N-methylbutylamine), and hydroxides of alkali metals and alkali earth metals) and/or salts of the basic substance.

The phrase “before the coating layer exhibits a decreasing rate of drying” refers to a period of several minutes immediately after application of the coating liquid for the ink-receiving layer. The content of the solvent (dispersion medium) in the coating layer decreases in proportion to time, or exhibits a so-called “constant rate of drying”. The time exhibiting “constant rate of drying” is described in “Handbook of Industrial Chemistry” (pages 707-712, Maruzen Co., (Oct. 25, 1980)).

After coating the coating liquid, the coating layer is dried until it exhibits a decreasing rate of drying, and the drying is generally performed at 40 to 180° C. for 0.5 to 10 minutes (preferably 0.5 to 5 minutes). Although the necessary drying time differs depending on the amount of the coating, the above-mentioned time range is usually appropriate.

Examples of the method for applying the coating liquid B before the coating layer exhibits a decreasing rate of drying include (1) applying the coating liquid B onto the coating layer, (2) spraying the coating liquid B using a spray, or the like, and (3) immersing the substrate having the coating layer thereon in the coating liquid B.

Examples of the coating method for applying coating liquid B in the method of (1) include known methods using a curtain flow coater, extrusion die coater, air doctor coater, bread coater, rod coater, knife coater, squeeze coater, reverse roll coater and bar coater. It is preferable to use methods in which the coater is not directly touched to the already formed first coating layer, and examples of such a method include methods using the extrusion die coater, curtain flow coater and bar coater.

After applying the basic solution (coating liquid B), the layer is cured and dried by heating preferably at 40 to 180° C. for 0.5 to 30 minutes, and more preferably at 40 to 150° C. for 1 to 20 minutes.

When the basic solution (coating liquid B) is applied simultaneously with application of the coating liquid for the ink-receiving layer (coating liquid A), the coating liquid for the ink-receiving layer (coating liquid A) and the basic solution (coating liquid B) are simultaneously applied on the substrate so that the coating liquid for the ink-receiving layer (coating liquid A) directly contact the substrate, and thereafter the ink-receiving layer is formed by being dried and cured.

The coating liquids may be simultaneously applied (layer overlap coating) using the extrusion die coater and curtain flow coater. The formed coating layers are dried after simultaneous coating. The drying condition of the coating layers is preferably heating at 40 to 150° C. for 0.5 to 10 minutes, and more preferably heating at 40 to 100° C. for 0.5 to 5 minutes.

When the layers are simultaneously applied (layer overlap coating) using the extrusion die coater, for example, the simultaneously ejected two coating liquids form dual layers near the extrusion port of the extrusion die coater. In other words, the dual layers are formed before the layers are transferred onto the substrate, and the formed dual layers are applied on the substrate as they are. Since the dual layers overlapped before coating tend to cause a crosslinking reaction at the interface therebetween, the extruded two liquids ejected near the extrusion port may be mixed and the viscosity thereof tends to increase, thereby causing troubles in the coating process. Accordingly, when the liquids are simultaneously applied as described above, it is preferable to interpose a barrier layer liquid (intermediate layer liquid) between the coating liquid for the ink-receiving layer (coating liquid A) and basic solution (coating liquid B) and to simultaneously apply the three layers.

There is no particular limitation on the selection of the barrier layer coating liquid. Examples of such a barrier layer coating liquid include an aqueous solution containing a small amount of a water-soluble resin, and water. The water-soluble resin serves as a tackifier for the sake of coatability. Examples of such a water-soluble resin include polymers such as cellulosic resins (e.g., hydroxypropylmethyl cellulose, methyl cellulose, hydroxyethylmethyl cellulose), polyvinylpyrrolidone and gelatin. The above-mentioned mordant may also be added to the barrier layer coating liquid.

After formed on the substrate, the ink-receiving layer may be calendered. For example, using a super calender or gloss calender, the ink-receiving layer disposed on the substrate is passed through roll nips under heat and pressure. Thus calendered, the surface smoothness, the glossiness, the transparency and the strength of the layer can be increased. However, since the calendering treatment will often lower the porosity of the layer (namely, the ink absorbing property of the layer will be lowered), its condition must be so controlled that the porosity of the layer does not much lowered after the calendering treatment.

The roll temperature for the calender treatment is preferably 30 to 150° C., and more preferably 40 to 100° C.

The linear pressure between the rolls for the calender treatment is preferably 50 to 400 kg/cm, and more preferably 100 to 200 kg/cm.

Since the ink-receiving layer is required to have an absorbing capacity for absorbing all the droplets in the ink-jet recording, the thickness of the ink-receiving layer should be determined in relation to the void ratio in the layer. For example, when the amount of ink is 8 nL/mm² and the void ratio is 60%, a thickness of about 15 μm or more is required for the layer.

The thickness of the ink-receiving layer is preferably 10 to 50 μm for ink-jet recording in view of the above-described conditions.

The diameter of the pore in the ink-receiving layer is preferably 0.005 to 0.030 μm, and more preferably 0.01 to 0.025 μm, in the median diameter.

The void ratio and median diameter of the void are measured using a mercury porosimeter (trade name Pore Sizer 9320-PC2, manufactured by Shimadzu Corporation).

The ink-receiving layer is preferably excellent in transparency. As a criteria of transparency, the haze value of the ink-receiving layer formed on a transparent film substrate is preferably 30% or less, and more preferably 20% or less.

The haze value is measured using a haze meter (trade name HGM-2DP, manufactured by Suga Test Machine Co.).

A polymer fine particle dispersion may be added to the layer for constituting the ink-jet recording medium of the invention (for example the ink-receiving layer or back layer). The polymer fine particle dispersion is used for improving the properties of the film such as dimensional stability, prevention of curl, prevention of adhesion and prevention of cracks of the layer. The polymer fine particle dispersion is described in JP-A Nos. 62-245258, 62-1316648 and 62-110066. Adding a polymer fine particle dispersion having a low glass transition temperature (not higher than 40° C.) to the layer containing the mordant is effective for preventing the layer from being cracked or curled. Curling can be prevented by adding a polymer fine particle dispersion having a high glass transition temperature to the back layer.

The ink-jet recording medium of the invention can be also manufactured by the methods described in JP-A Nos. 10-81064, 10-19423, 10-157277, 10-217601, 11-348409, 2001-138621, 2000-43401, 2000-211235, 2000-309157, 2001-96897, 2001-138627, 11-91242, 8-2087, 8-2090, 8-2091 and 8-2093.

The undercoat layer may be provided between the ink-receiving layer and substrate for enhancing adhesivity, appropriately controlling electrical resistance, and so forth.

The ink-receiving layer may be provided on only one face of the substrate, or on both faces of the substrate for preventing the substrate from being curled. When the medium is used as an OHP film, or the like and the ink-receiving layer is provided on one face of the substrate, a reflection preventive layer may be provided on the face opposite the ink-receiving layer, or on both faces of the substrate for enhancing light permeability.

Lubricity and surface smoothness is ensured by applying boric acid or a boron compound on the surface of the substrate on which the ink-receiving layer is formed, and by forming the ink-receiving layer thereon. This permits time-dependent blurring of the image after printing under a high temperature high humidity environment to be suppressed.

### EXAMPLES

The present invention will be described in detail with reference to the examples. However, the following examples should not be constructed to limit the scope of the invention. “Parts” and “%” in the examples means “parts by mass” and “% by mass”.

(Preparation of Substrate)

An wood pulp comprising 100 parts of LKB was beaten to Canadian freeness of 300 ml with a double disk refiner. Epoxylated behenic acid amide (0.5 parts), anionic polyacrylamide (1.0 parts), polyamide polyamine epichlorohydrin (0.1 parts) and cationic polyacrylamide (0.5 parts) were added as an absolute dry mass ratio to the pulp. A base sheet with a grammage of 170 g/m² using a Fourdrimier paper machine.

A fluorescent whitening agent (0.04%, trade name Whitex BB, manufactured by Sumitomo Chemical Industry Co.) was added to a 4% aqueous solution of polyvinyl alcohol for adjusting surface size of the base sheet. After immersing the base sheet in the solution above and drying the base sheet to a grammage of 0.5 g/m² as converted into an absolute dry mass, the density of the base sheet was controlled to 1.05 g/cm³ (g/cc) by applying a calender treatment.

A corona discharge treatment was applied on the wire face (back side) of the base sheet, and subsequently high density polyethylene was coated to a thickness of 19 μm using a melt-extruder to form a resin layer comprising the mat face (the side of this resin layer is referred to as a back side, hereinafter). After an additional corona discharge treatment on the resin layer at the back side, a dispersion solution, which is prepared by dispersing aluminum oxide (alumina sol 100 manufactured by Nissan Chemical Industry Co.) and silicon dioxide (trade name Snow Tex O, manufactured by Nissan Chemical Industry Co.) in water in 1:2 mass ratio, was applied in a grammage of 0.2 g/m² as an antistatic agent.

The corona discharge treatment was further applied to a felt face (front side) having no resin layer disposed. Subsequently, low density polyethylene, which contained 10% of anatase-type titanium dioxide, a trace amount of ultramarine and 0.01% of fluorescent whitening agent (based on the mass of the polyethylene resin) and which has a MFR (melt flow rate) of 3.8, was extruded with a thickness of 29 μm using a melt-extruder to form a highly glossy thermoplastic resin layer on the front side of the base sheet (hereinafter, this highly glossy side is referred to as “front side”) so as to obtain a substrate.

### Example 1

(Preparation of Coating Solution A of the Ink-Receiving Layer)

The coating liquid A was prepared by mixing (1) fumed silica fine particles, (2) ion exchange water, (3) Sharol DC-902P and (4) zirconyl acetate followed by dispersing using Beads Mill KD-P manufactured by Shinmaru Enterprises Co., and by mixing a solution containing (5) polyaluminum chloride, (6) SC-5505, (7) polyvinyl alcohol, (8) boric acid, (9) polyoxyethylene lauryl ether and (10) ion exchange solution.

<Composition of coating solution A for ink-receiving layer>

| | | | |
|---|---|---|---|
| (1) | fumed silica fine particles (inorganic fine particles) | 16.0 | parts |
| | (trade name Rheo Seal QS-30, manufactured by | | |
| | Tokuyama Co.) | | |
| (2) | ion exchange water | 89.2 | parts |
| (3) | polydimethydiallyl ammonium salt (51% aqueous | 1.6 | parts |
| | solution, trade name Sharol DC-902P, manufactured | | |
| | by Dai-Ichi Kogyo Seiyaku Co.) | | |
| (4) | zirconyl acetate (trade name Zircosol ZA-30, | 1.3 | parts |
| | manufactured by Dai-Ichi Rare Element Industry | | |
| | Co.) | | |
| (5) | polyaluminum chloride (trade name Alfine 83, | 2.3 | parts |
| | manufactured by Daimei Chemical Industry Co.) | | |
| (6) | dimethylamine-epichlorohydrin-polyalkylene | 0.4 | parts |
| | polyamine polycondensation product (50% aqueous | | |
| | solution, trade name SC-505, manufactured by | | |
| | Hymo Co, Ltd.) | | |
| (7) | polyvinyl alcohol (water-soluble resin) (7% aqueous | 50.6 | parts |
| | solution, trade name PVA 224, manufactured by | | |
| | Kuraray Co.) | | |
| (8) | boric acid (crosslinking agent) | 0.65 | parts |
| (9) | polyoxyethylene lauryl ether (surfactant) | 0.2 | parts |
| | (10% aqueous solution, trade name Emulgen 109P, | | |
| | manufactured by Kao Corporation) | | |
| (10) | ion exchange water | 20.05 | parts |

(Preparation of Ink-Jet Recording Medium (1))

A corona discharge treatment was applied to the front side of the substrate. Subsequently, the coating liquid A for the ink-receiving layer obtained above was applied to the front side of the substrate with a coating amount of 180 ml/m² (coating step). Thereafter, the coating layer was dried using a hot-air stream dryer at 80° C. (air blow rate of 3 to 8 m/second) until the solid fraction concentration of the coating layer became 20%. This coating layer exhibited a constant rate of drying. Immediately after drying, the substrate was immersed in basic coating liquid B having a composition described below for 30 seconds to adhere the coating liquid B on the coating layer with a density of 15 g/m² (basic coating liquid adhesion step) followed by drying at 80° C. for 10 minutes (drying step). Ink-jet recording medium (1) of the invention comprising the ink-receiving layer having a dry thickness of 35 μm was thus obtained.

<Composition of basic coating liquid B>

| | | | |
|---|---|---|---|
| (1) | ion exchange water | 93.05 | parts |
| (2) | boric acid (crosslinking agent) | 0.65 | parts |
| (3) | ammonium carbonate (manufactured by Kanto | 2.0 | parts |
| | Chemical Co., analytical grade) | | |
| (4) | zircoammonium carbonate (trade name Zircosol AC-7, | 3.9 | parts |
| | manufactured by Dai-Ichi Rare Element Chemical | | |
| | Industry Co.) | | |
| (5) | polyoxyethylene lauryl ether (trade name Emulgen | 0.2 | parts |
| | 109P, manufactured by Kao Corporation) | | |
| (6) | Megaface F1405 (trade name, manufactured by Dai- | 0.2 | parts |
| | Nippon Ink chemical Industry Co.) | | |

### Example 2

(Preparation of Ink-Jet Recording Medium (2))

Ink-jet recording medium (2) of the invention was prepared in the same manner as in Example 1, except in that 0.5 parts of a dicyanediamide-polyalkylene polyamide condensate (40% aqueous solution, trade name Amigen NF, manufactured by Dai-Ichi Kogyo Seiyaku Co.) was added in place of 0.4 parts of SC-505 manufactured by Hymo Co, Ltd. used in the composition of coating liquid A for the ink-receiving layer.

### Example 3

(Preparation of Ink-Jet Recording Medium (3))

Ink-jet recording medium (3) of the invention was prepared in the same manner as in Example 1, except in that 0.7 parts of a polyamidine (30% aqueous solution, trade name SC-700, manufactured by Hymo Co, Ltd.) was added in place of 0.4 parts of SC-505 manufactured by Hymo Co, Ltd. used in the composition of coating liquid A for the ink-receiving layer.

### Example 4

(Preparation of Ink-Jet Recording Medium (4))

Ink-jet recording medium (4) of the invention was prepared in the same manner as in Example 1, except in that 0.1 parts of following compound (1) was further added as a chelating agent in the composition of coating liquid A for the ink-receiving layer.

### Example 5

(Preparation of Ink-Jet Recording Medium (5))

Ink-jet recording medium (5) of the invention was prepared in the same manner as in Example 2, except in that 0.1 parts of following compound (1) was further added as a chelating agent in the composition of coating liquid A for the ink-receiving layer.

### Example 6

(Preparation of Ink-Jet Recording Medium (6))

Ink-jet recording medium (6) of the invention was prepared in the same manner as in Example 5, except in that 4.0 parts of the following compound (2) (solid fraction 25%) was added as a sulfur-containing compound in the composition of coating liquid A for the ink-receiving layer.

### Comparative Example 1

(Preparation of Ink-Jet Recording Medium (7))

Ink-jet recording medium (7) was prepared in the same manner as in Example 1, except in that 0.4 parts of SC-505 (trade name, manufactured by Hymo Co, Ltd.), which was used in Example 1, was not used in the composition of coating liquid A for the ink-receiving layer.

### Comparative Example 2

(Preparation of Ink-Jet Recording Medium (8))

Ink-jet recording medium (8) was prepared in the same manner as in Example 1, except in that 1.6 parts of Sgarol DC-902P (trade name, manufactured by Dai-Ichi Kogyo Seiyaku Co.), which was used in Example 1, was not used in the composition of coating liquid A for the ink-receiving layer. 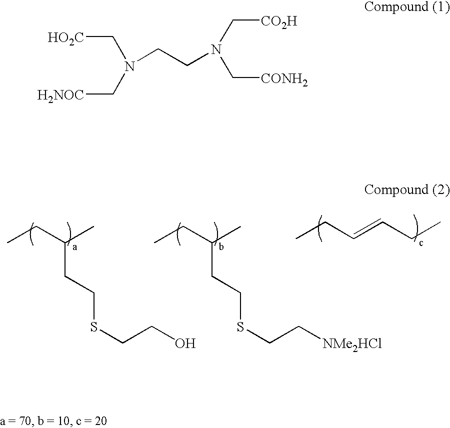
(Evaluation Test of Ozone Resistance)

Solid images of magenta (M) and cyan (C) were printed, respectively, on each ink-jet recording medium obtained using an ink-jet printer PM-G800 (trade name, manufactured by Seiko Epson Co., and the images were stored for 96 hours in an environment containing 10 ppm of ozone. Color densities of magenta (M) and cyan (C) before and after storage were measured, respectively, using a refraction densitometer Xrite 938 (trade name, manufactured by Xrite Co.) to calculate residua ratios of the magenta concentration and cyan concentration. The results are shown in Table 1 below.

(Measurement of Viscosity)

Viscosity of each liquid immediately after preparation and 24 hours after preparation of the coating liquid A for the ink-receiving layer for manufacturing each ink-jet recording medium was measured using a type B viscometer RB-80L (trade name, manufactured by Toyo Sangyo Co.) at 30° C. with a rotation speed of 60 rpm. The results are shown in Table 1.

The I/O ratio of the cationic polymer used in each example was also filled in Table 1 below. However, since Amigen NF (trade name) does not have a distinct polymer structure, an average value of the I/O ratios of the monomer components was used as the I/O ratio of the polymer.

(Evaluation of Coating Surface)

The surface state of the coating surface on which the ink-receiving layer was provided was evaluated for each ink-jet recording medium according to the following criteria. The results are shown in Table 1.

(Criteria)

A: no coating defects such as painting stripes, foam and repelling were observed
B: no practical problems, although a little coating defects were observed

C: impossible to provide for practical use due to too many coating defects

TABLE 1

| | | | | | Liquid Viscosity at 30° C. | | State of | | |
|---|---|---|---|---|---|---|---|---|---|
| | | | | | (mPa · s) | | Coating | Ozone Resistance | |
| | Cationic | Cationic | | Sulfur- | Immediately | | Layer | Residual | Residual |
| | Polymer (a), | Polymer (b), | Chelating | Containing | after | after 24 | (Foam, | ratio | Ratio |
| | I/O ratio | I/O ratio | Agent | Compound | Preparation | Hours | Stripe, etc.) | of M | of C |
| Example 1 | DC-902P, 2.5 | SC-505, 3.7 | — | — | 200 | 250 | B | 64% | 75% |
| Example 2 | DC-902P, 2.5 | Amigen NF, 2.8 | — | — | 285 | 380 | B | 70% | 84% |
| Example 3 | DC-902P, 2.5 | SC-700, 4.6 | — | — | 285 | 385 | B | 65% | 74% |
| Example 4 | DC-902P, 2.5 | SC-505, 3.7 | Compaund(1) | — | 100 | 105 | A | 69% | 80% |
| Example 5 | DC-902P, 2.5 | Amigen NF, 2.8 | Compaund(1) | — | 137 | 155 | A | 75% | 89% |
| Example 6 | DC-902P, 2.5 | Amigen NF, 2.8 | Compaund(1) | Compaund(2) | 95 | 145 | A | 81% | 91% |
| Comparative | DC-902P, 2.5 | — | — | — | 250 | 400 | B | 59% | 63% |
| Example 1 | | | | | | | | | |
| Comparative | — | SC-505, 3.7 | — | — | 1000 or | (Impossible | C | — | — |
| Example 2 | | | | | more | to | | | |
| | | | | | | measure) | | | |

Table 1 clearly shows that the ink-jet recording media (1) to (6) of the present Examples, which has an ink-receiving layer containing the cationic organic polymers having I/O ratios according to the invention, were excellent in ozone resistance as compared to the recording media (7) and (8) in Comparative Examples. The ink-jet recording media (4) to (6) containing a chelating agent showed better results in ozone resistance. Among them, the ink-jet recording medium (6) containing a chelating agent and a sulfur-containing compound showed most excellent results in ozone resistance.

Furthermore, the coating liquid for the ink-receiving layer of the ink-jet recording media (1) to (6) of the invention was very stable with a low viscosity. It was revealed that the present invention provides an ink-jet recording media having excellent coating surface conditions, and also provides a method for producing an ink-jet recording media that is excellent in productivity.

1. An ink-jet recording medium comprising a substrate and an ink-receiving layer disposed on the substrate, wherein the ink-receiving layer comprises a water-soluble resin, a first cationic organic polymer having an inorganicity/organicity (I/O) ratio of less than 2.8 and a second cationic organic polymer having an inorganicity/organicity (I/O) ratio of 2.8 or more.

2. The ink-jet recording medium of claim 1, wherein the first cationic organic polymer having an I/O ratio of less than 2.8 has an I/O ratio of 1 or more and less than 2.8, and the second cationic organic polymer having an I/O ratio of 2.8 or more has an I/O ratio of 2.8 to 10.

3. The ink-jet recording medium of claim 1, wherein the first cationic organic polymer having an I/O ratio of less than 2.8 has an I/O ratio of 1.8 or more and less than 2.8, and the second cationic organic polymer having an I/O ratio of 2.8 or more has an I/O ratio of 2.8 to 6.0.

4. The ink-jet recording medium of claim 1, wherein the ink-receiving layer further comprises particles.

5. The ink-jet recording medium of claim 1, wherein a mass ratio between the first cationic organic polymer having an I/O ratio of less than 2.8 contained in the ink receiving layer and the second cationic organic polymer having an I/O ratio of 2.8 or more contained in the ink receiving layer is in a range of 1:5 to 40:1.

6. The ink-jet recording medium of claim 1, wherein a mass ratio between the first cationic organic polymer having an I/O ratio of less than 2.8 contained in the ink receiving layer and the second cationic organic polymer having an I/O ratio of 2.8 or more contained in the ink receiving layer is in a range of 1:2 to 10:1.

7. The ink-jet recording medium of claim 1, wherein a mass ratio between the first cationic organic polymer having an I/O ratio of less than 2.8 contained in the ink receiving layer and the second cationic organic polymer having an I/O ratio of 2.8 or more contained in the ink receiving layer is in a range of 1:1 to 5:1.

8. The ink-jet recording medium of claim 1, wherein the first cationic organic polymer having an I/O ratio of less than 2.8 comprises at least one selected from the group consisting of dimethyldiallyl ammonium chloride, (meth)acrylate of trialkyl ammonium salt, and a copolymer of (meth)acrylate of trialkyl ammonium salt and styrene.

9. The ink-jet recording medium of claim 1, wherein the first cationic organic polymer having an I/O ratio of less than 2.8 comprises at least one of dimethyldiallyl ammonium chloride, and a copolymer of trimethylammonium ethyl methacrylate and styrene.

10. The ink-jet recording medium of claim 1, wherein the second cationic organic polymer having an I/O ratio of 2.8 or more comprises at least one selected from the group consisting of polyallylamine, polyethylenimine, polyvinylamine, polyamidine, a dimethylamine-epichlorohydrin polycondensation product and a dicyan-diamide polycondensation product.

11. The ink-jet recording medium of claim 1, wherein the second cationic organic polymer having an I/O ratio of 2.8 or more comprises at least one selected from the group consisting of a dimethylamine-epichlorohydrin-polyalkylene polyamine polycondensation product and a dicyandiamide-polyalkylene polyamine polycondensation product.

12. The ink-jet recording medium of claim 1, wherein the ink-receiving layer comprises at least one chelating agent.

13. The ink-jet recording medium of claim 1, wherein the ink-receiving layer comprises at least one sulfur-containing compound.

14. The ink-jet recording medium of claim 1, wherein a total amount of cationic polymers contained in the ink receiving layer is 0.1 g/m² to 5 g/m².

15. A method for producing the ink-jet recording medium of claim 1, the method comprising:
coating, on a substrate, a coating liquid comprising a water-soluble resin, a first cationic organic polymer having an I/O ratio of less than 2.8 and a second cationic organic polymer having an I/O ratio of 2.8 or more so as to form a coating layer; and
applying a basic solution having a pH of 7.1 or more onto the coating layer either (1) simultaneously with formation of the coating layer by application of the coating liquid or (2) during drying of the coating layer formed by application of the coating liquid and before the coating layer exhibits a decreasing rate of drying so as to cure the coating layer, wherein a crosslinking agent is added to at least one of the coating liquid and the basic solution.
